(19) United States
(12) Patent Application Publication
(10) Pub. No.: US 2019/0300171 A1
(43) Pub. Date: Oct. 3, 2019

(54) MOVING BODY

(71) Applicant: SHARP KABUSHIKI KAISHA, Sakai City, Osaka (JP)

(72) Inventor: TAKATOSHI MORITA, Sakai City (JP)

(21) Appl. No.: 16/315,917

(22) PCT Filed: Jul. 28, 2017
(86) PCT No.: PCT/JP2017/027386

§ 371 Date: Jan. 7, 2019

(30) Foreign Application Priority Data
Jul. 29, 2016 (JP) 2016-150612

(51) Int. Cl. B64C 39/02; B64D 47/00; F21V 29/503; F21V 29/70; F21V 29/67; F21V 9/30; F21V 8/00

(52) U.S. Cl. CPC B64C 39/024; B64D 47/00; F21V 29/503; F21V 29/70; B64C 2201/108; F21V 9/30; G02B 6/0008; B64C 2201/027; F21V 29/67

(57) ABSTRACT

A moving body is provided that is capable of suppressing a rise in temperature of a light source and radiating high-luminance light. An unmanned aircraft (1A) is an unmanned aircraft that gains propulsion through a fan (4), including a laser unit (10A) that emits a laser beam (L1), wherein the laser unit (10A) has its heat dissipation efficiency enhanced by air that is blasted by the fan (4).

### TECHNICAL FIELD

The present invention relates to a moving body including a fan that serves as a propulsion device.

### BACKGROUND ART

The development and commercialization of unmanned aircrafts called UAV (unmanned aerial vehicles) or drones have long been on the way. Moreover, thanks to the miniaturization of sensors, the miniaturization and enhanced performance of communications and control equipment, and the like, the commercialization of unmanned aircrafts in the private sector has recently become active.

Recently commercialized unmanned aircrafts are mostly of a multicopter type with a plurality of fans (propellers). Such a type of unmanned aircraft is capable of stable hovering flight, i.e. of staying in one place in the air, and has a great advantage in that its attitude can be easily controlled with respect to the place it stays in the air.

An unmanned aircraft has a central part (terminal part) in which sensors and electronic equipment for performing advanced control in the air as well as flight operation are concentrated. As sensors, electronic equipment, and the like generate heat during operation, the concentration of sensors and electronic equipment in the central part leads to a rise in temperature of the central part, undesirably causing these pieces of equipment to malfunction or fail.

A technology for solving the foregoing problem is disclosed in PTL 1. An unmanned aircraft disclosed in PTL 1 includes a duct and a fan blade, with electronic equipment (heat generating equipment) accommodated inside the duct. According to this, a current of air that is generated by rotating the fan blade is used to cool down the electronic equipment (heat generating equipment) accommodated in the duct.

Further, there has been known an unmanned aircraft including a lighting device. For example, PTL 2 discloses an autonomous mobile lighting apparatus including a lighting device. The autonomous mobile lighting apparatus disclosed in PTL 2 includes a photoelectric conversion section, a light-emitting section, a light sensor, and a propeller, and the interiors of the photoelectric conversion section and the light-emitting section, which are closed in spindle shapes, are filled with a gas (such as helium) that is lighter than air, so that the autonomous mobile lighting apparatus can float in the air. Moreover, the autonomous mobile lighting apparatus moves as appropriate while floating in the air. During the day, the autonomous mobile lighting apparatus can photovoltaically generate electricity or be charged with the photoelectric conversion section facing sunlight, and during the night, the autonomous mobile lighting apparatus can emit or radiate light with the light-emitting section facing a desired irradiation surface.

### CITATION LIST

### Patent Literature

PTL 1: Japanese Patent No. 5378065 (registered on Oct. 4, 2013)

PTL 2: Japanese Patent No. 5720456 (registered on Apr. 3, 2015)

PTL 3: Japanese Patent No. 5271600 (registered on May 17, 2013)

### SUMMARY OF INVENTION

### Technical Problem

However, the autonomous mobile lighting apparatus disclosed in PTL 2 is not intended to radiate high-flux, high-luminance light, as the light-emitting section used is an organic EL (electroluminescence) element or an LED (light-emitting diode).

Incidentally, in order for a lighting apparatus (e.g. a lighting apparatus disclosed in PTL 3) including an LED element or an HID (high-intensity discharge) element to radiate high-flux, high-luminance light, the lighting apparatus needs to be larger in size. Accordingly, the lighting apparatus needs to be heavier in weight, undesirably burning more cell (battery) power when mounted on a moving body.

In order for a lighting apparatus that is mounted on a moving body to be a small-sized lighting apparatus, a small-sized floodlighting system is needed, and attention is focused on a high-luminance light source (light-emitting element) that makes a small-sized floodlighting system feasible. A possibly usable example of such a light source is a laser element. However, in a case where a laser element is used as a light-emitting element, the laser element generates a large amount of heat in radiating a laser beam. This results in a rise in temperature of the laser element, undesirably causing a decrease in light emission efficiency of the laser element.

The present invention has been made in order to solve the foregoing problems, and it is an object of the present invention to provide a moving body, including a light source, that is capable of suppressing a rise in temperature of the light source and radiating high-luminance light from the light source.

### Solution to Problem

In order to solve the foregoing problems, a moving body according to an aspect of the present invention is a moving body that gains propulsion through a fan, including at least one light source that emits a laser beam, wherein the light source has its heat dissipation efficiency enhanced by air that is blasted by the fan.

### Advantageous Effects of Invention

An aspect of the present invention brings about an effect of making it possible to provide a moving body, including a light source, that is capable of suppressing a rise in temperature of the light source and emitting high-luminance light from the light source.

### BRIEF DESCRIPTION OF DRAWINGS

FIG. 1 is a schematic view showing an overall configuration of an unmanned aircraft according to Embodiment 1 of the present invention.

FIG. 2 is a cross-sectional view showing a configuration of the unmanned aircraft.

FIG. 3 illustrates a method for fixing a laser element to an arm section using a fixing jig in the unmanned aircraft, (a) being a front view of the fixing jig, (b) being a cross-sectional view of the fixing jig.

FIG. 4 shows how a light-emitting section is used in a state of being mounted on a substrate in the unmanned aircraft, (a) showing a state where the light-emitting section is mounted on a translucent substrate, (b) showing a state where the light-emitting section is mounted on a light-reflecting substrate.

FIG. 5 is a schematic view showing a configuration of a floodlighting section of the unmanned aircraft.

FIG. 6 is an explanatory diagram showing the volume of air on a discharge side of a fan of the unmanned aircraft.

FIG. 7 is a top view of the fan and the area therearound in the unmanned aircraft in a state where the fan is rotating.

FIG. 8 is a cross-sectional view showing a configuration of an unmanned aircraft according to a modification of the unmanned aircraft.

FIG. 9 is a cross-sectional view showing a configuration of an unmanned aircraft according to Embodiment 2 of the present invention.

FIG. 10 is a top view of a fan and the area therearound in the unmanned aircraft in a state where the fan is rotating.

FIG. 11 is a cross-sectional view showing a configuration of an unmanned aircraft according to a modification of the unmanned aircraft.

FIG. 12 is a cross-sectional view showing a configuration of an unmanned aircraft according to Embodiment 3 of the present invention.

FIG. 13 is a cross-sectional view showing a configuration of an unmanned aircraft according to a modification of the unmanned aircraft.

FIG. 14 is a schematic view showing an overall configuration of an unmanned aircraft according to Embodiment 4 of the present invention.

FIG. 15 is a cross-sectional view showing a configuration of the unmanned aircraft.

FIG. 16 is a top view of a fan and the area therearound in the unmanned aircraft in a state where the fan is rotating.

FIG. 17 is a cross-sectional view showing a configuration of an unmanned aircraft according to Embodiment 5 of the present invention.

FIG. 18 is a cross-sectional view showing a configuration of an unmanned aircraft according to Embodiment 6 of the present invention.

FIG. 19 is an explanatory diagram showing a method for merging laser beams that are emitted from a laser unit of the unmanned aircraft.

FIG. 20 is a cross-sectional view showing a configuration of an unmanned aircraft according to Embodiment 7 of the present invention.

FIG. 21 is a cross-sectional view showing a configuration of a fan and the area therearound of an unmanned aircraft according to Embodiment 8 of the present invention.

FIG. 22 is a cross-sectional view showing a configuration of a fan and the area therearound of an unmanned aircraft according to Embodiment 9 of the present invention.

### DESCRIPTION OF EMBODIMENTS

### Embodiment 1

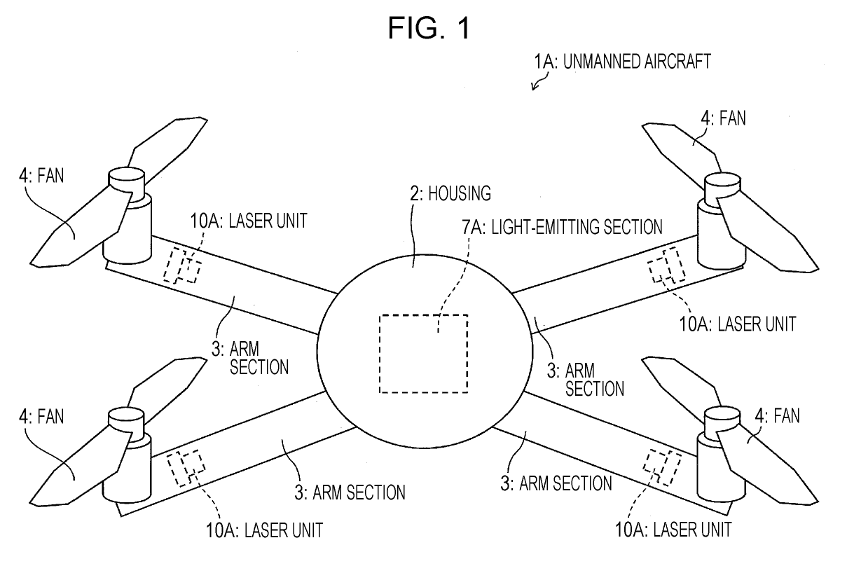

The following describes an unmanned aircraft 1A with reference to FIGS. 1 to 6 as a moving body according to Embodiment 1 of the present invention that gains propulsion through a fan.

(Configuration of Unmanned Aircraft 1A)

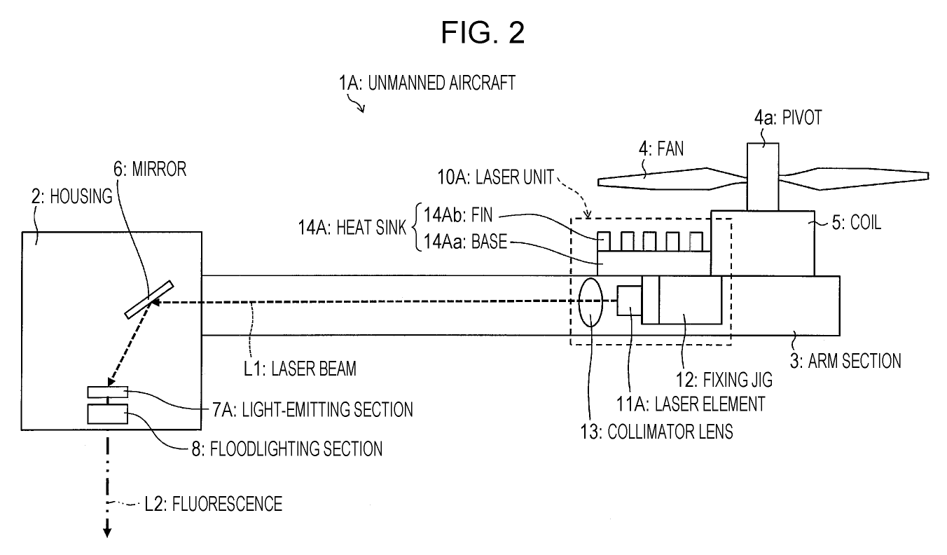

A configuration of the unmanned aircraft 1A is described with reference to FIGS. 1 and 2. FIG. 1 is a schematic view showing an overall configuration of the unmanned aircraft 1A. FIG. 2 is a cross-sectional view showing a configuration of the unmanned aircraft 1A.

As shown in FIGS. 1 and 2, the unmanned aircraft 1A includes a housing (body section) 2, arm sections 3, fans 4, coils 5, laser units (light sources) 10A, a mirror 6, a light-emitting section 7A, and a floodlighting section 8.

The housing 2 serves to house a control section (not illustrated), a sensor (not illustrated), a battery (not illustrated), and the like that are used for performing advanced flight operation of the unmanned aircraft 1A. Further, the housing 2 also houses the mirror 6, the light-emitting section 7A, and the floodlighting section 8.

Each of the arm sections 3 is an elongated member extending from the housing 2, and has an empty space inside. The unmanned aircraft 1A is provided with four of these arm sections 3.

The fans 4 are propellers that rotate to give buoyancy for the unmanned aircraft 1A to float in the air and propulsion for the unmanned aircraft 1A to move through the air. Each of the fans 4 is attached on top of the corresponding one of the arm sections 3 by having its pivot 4a supported at an end of the arm section 3 opposite to the housing 2.

Each of the coils 5 is a driving section for rotating the corresponding one of the fans 4. The coil 5 controls the direction and speed of rotation of the fan 4 in accordance with instructions from the control section. This enables the unmanned aircraft 1A to float in the air or move through the air.

Each of the laser units 10A is a light source that emits a laser beam L1. Each of the arm sections 3 is provided with one laser unit 10A. Each of the laser units 10A includes a laser element 11A, a fixing jig 12, a collimator lens 13, and a heat sink 14A. Although the unmanned aircraft 1A is configured such that each of the arm sections 3 is provided with a laser unit 10A, an unmanned aircraft (moving body) of the present invention is not limited to this configuration. That is, at least one of the arm sections 3 needs only be provided with a laser unit 10A, and for example, an unmanned aircraft (moving body) of the present invention may be configured such that only two of the four arm sections 3 are provided with laser units, respectively.

The laser element 11A is a light-emitting element that emits the laser beam L1. The laser element 11A is provided inside the arm section 3. The laser element 11A may be one that has one luminous point on one chip, or may be one that has a plurality of luminous points on one chip. A wavelength of the laser beam L1 that is emitted from the laser element 11a is, for example, 365 nm to 460 nm, or preferably, 390 nm to 410 nm; however, the wavelengths is not limited to these values but needs only be selected as appropriate according to the type of phosphor that the light-emitting section 7A has. Usable examples of the laser element 11A include, but are not limited to, a CAN-packaged laser element. The laser element 11A is fixed to the arm section 3 by the fixing jig 12.

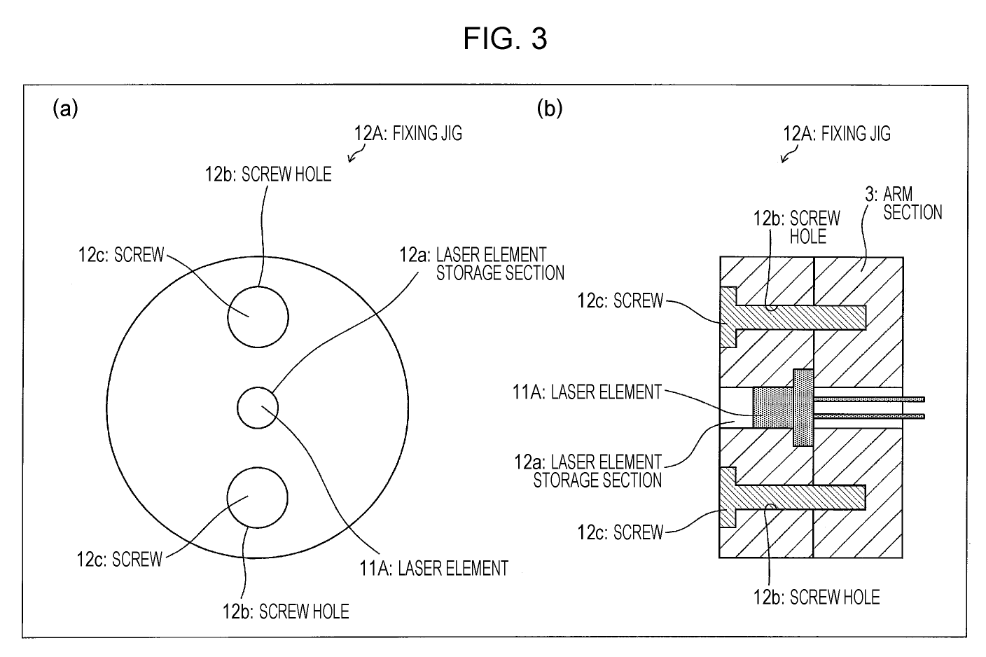

The fixing jig 12 is a member for fixing the laser element 11A to the fixing jig 12 and fixing the laser element 11A to the arm section 3. It is preferable that the fixing jig 12 be made of a highly heat-dissipative material. As shown in FIG. 2, the fixing jig 12 is provided so that the laser element 11A is fixed to an outer side of the fixing jig 12. Note, however, that an unmanned aircraft (moving body) of the present invention is not limited to this. For example, as shown in FIG. 3, the laser element 11A may be fixed to the arm section 3. FIG. 3 illustrates a method for fixing a laser element 11A to an arm section 3 using a fixing jig 12A, (a) being a front view of the fixing jig 12A, (b) being a cross-sectional view of the fixing jig 12A. As shown in (a) and (b) of FIG. 3, the fixing jig 12A includes a laser element storage section 12a, two screw holes 12b, and two screws 12c. The laser element 11A is stored in the laser element storage section 12a. Moreover, the fixing jig 12A is fixed to the arm section 3 by screwing the screws 12c into the screw holes 12b and screwing the points of the screws 12c into screw holes (not illustrated) of the arm section 3. As a result, the laser element 11A is fixed to the arm section 3. Further, it is preferable that the fixing jig 12A have a connector, wiring, and the like that are devised to pass an electric current through the laser element 11A. Further, the arm section 3 shown in FIG. 3 may serve as a fixing jig that is different from the fixing jig 12A so that the laser element 11A is fixed by being held between the two fixing jigs, at least one of which is fixed to the arm section 3.

The collimator lens 13 is a lens for turning the laser beam L1 emitted from the laser element 11A into a parallel ray. The collimator lens 13 is provided inside the arm section 3. It is preferable that the collimator lens 13 be a glass lens or a plastic lens, and it is more preferable that the collimator lens 13 be an aspherical lens. It is preferable that the collimator lens 13 be fixed to the arm section 3 so that its installation position can be finely adjusted. Alternatively, the laser element 11A and the collimator lens 13 may be a unit by being fixed to each other with adjustment. A fixing method for fixing the collimator lens 13 to the arm section 3 may be a method for physical or mechanical fixation. Further, the installation position of the collimator lens 13 may be electrically adjustable.

The heat sink 14A serves to dissipate heat generated by the laser element 11A radiating the laser beam L1. For this reason, it is preferable that the heat sink 14A be made of a highly thermally-conducting metal material such as copper or aluminum. The heat sink 14A includes a base 14Aa and fins 14Ab.

The base 14Aa is a flat-plate member with the laser element 11A connected to a lower surface thereof and with the plurality of fins 14Ab formed on an upper surface thereof.

The fins 14Ab are radiator plates protruding from the upper surface of the base 14Aa toward the fan 4, and enhance heat dissipation efficiency of the heat sink 14A by increasing an area of contact of the heat sink 14A with the atmosphere.

The heat sink 14A is provided on top of an outer part of the arm section 3. More specifically, the base 14Aa, which is connected to the laser element 11A, is placed on the outer part of the arm section 3, and the fins 14Ab protrude upward from the base 14Aa. Although not illustrated, the arm section 3 has an opening formed in a part thereof where the laser element 11A and the base 14Aa are connected to each other. This allows the laser element 11A and the base 14Aa to make contact with each other. The position where the heat sink 14A is provided will be explained in detail later.

The mirror 6 is a mirror, provided inside the housing 2, that serves to cause the laser beam L1 emitted from the laser unit 10A to be reflected toward the light-emitting section 7A after having arrived at the interior of the housing 2. Although the unmanned aircraft 1A is configured such that the mirror 6 is used to cause the laser beam L1 to be reflected toward the light-emitting section 7A, an unmanned aircraft (moving body) of the present invention is not limited to this configuration. For example, an unmanned aircraft (moving body) of the present invention may be configured such that a prism is used to cause the laser beam L1 to be refracted toward the light-emitting section 7A.

The light-emitting section 7A is provided inside the housing 2, and serves to emit fluorescence L2 by receiving the laser beam L1 reflected by the mirror 6 and converting the wavelength of the laser beam L1. In the example shown in FIG. 2, the light-emitting section 7A emits the fluorescence L2 mainly through a facing surface thereof opposite to a laser beam irradiation surface thereof that is irradiated with the laser beam L1. Such a light-emitting section is herein referred to as a “transmissive” light-emitting section.

In the present embodiment, the light-emitting section 7A is constituted by a single-crystal phosphor. By being irradiated with the laser beam L1, the single-crystal phosphor is excited to emit the fluorescence L2. A usable example of the single-crystal phosphor is a YAG (yttrium aluminum garnet, Y₃Al₅O₁₂) single-crystal phosphor. This phosphor is preferable, as it has high thermotolerance for the high-output laser beam L1 sent out from the laser unit 10A. Note, however, that the single-crystal phosphor is not limited to that mentioned above but may be another phosphor such as a nitride phosphor.

The light-emitting section 7A can radiate high-luminance light, e.g. light of 300 to 1000 Mcd/m², by using the laser beam L1 radiated from the laser unit 10A with which each arm section 3 is provided.

Further, the light-emitting section 7A radiates the fluorescence L2 by means of the laser beams L1 radiated from the laser units 10A with which the plurality of arm sections 3 are provided, respectively. This makes it possible to radiate more high-luminance light.

Although the light-emitting section 7A of the unmanned aircraft 1A according to the present embodiment is constituted by a single-crystal phosphor composed of a single crystal, the light-emitting section of an unmanned aircraft (moving body) of the present invention is not limited to this. For example, the light-emitting section may be a polycrystalline phosphor containing a plurality of fluorescent crystallites or may be formed by sealing phosphor particles inside a sealant such as a glass material or a resin material. An example of an inorganic compound that is used in a phosphor is YAG (yttrium aluminum garnet, Y₃Al₅O₁₂), which has a garnet structure, TAG (terbium aluminum garnet, Tb₃Al₅O₁₂:Ce), which has a garnet structure, or BOS (barium orthosilicate, (Ba,Sr)₂SiO₄:Eu), which is based on silicate. Note here that the phosphor may be particles of a single type of inorganic compound or may be a mixture of particles of plural types of inorganic compound. For example, a combination of inorganic compounds such as β sialon, α sialon, and CASN (CaAlSiN₃:Eu) may be used as the phosphor, or a combination of LuAG (lutetium aluminum garnet, Lu₃Al₅O₁₂:Ce) and CASN may be used as the phosphor. Mixing together particles of plural types of inorganic compound enables a phosphor element to emit light with higher color rendering properties.

The phosphor may be an inorganic compound in non-particle form or may be an organic compound or another fluorescent substance.

In an aspect of the present invention, a portion of the laser beam L1 radiated to the light-emitting section 7A can be prevented from being converted by the light-emitting section 7A into the fluorescence L2. This causes light containing the laser beam L1 and the fluorescence L2 to be radiated, thus making it possible to radiate a wider color gamut of light. For example, the laser beam L1 and the fluorescence L2 have their colors mixed by setting the wavelength of the laser beam L1 at 365 nm to 460 nm and using YAG as the phosphor of the light-emitting section 7A, so that white light may be emitted.

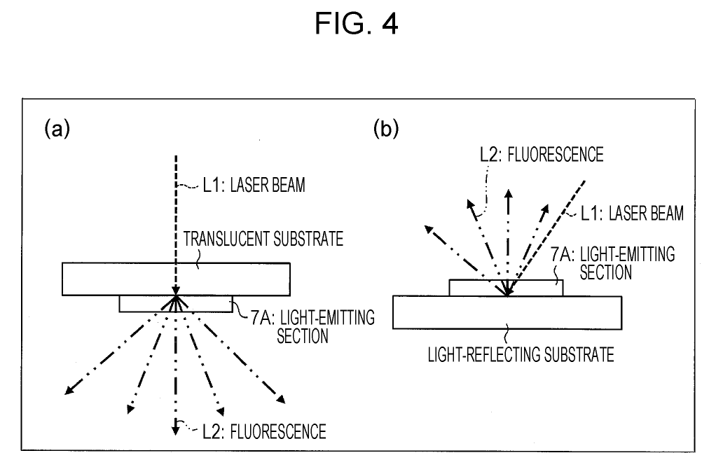

Further, although the light-emitting section 7A is configured to be used alone, an unmanned aircraft (moving body) of the present invention is not limited to this configuration. For example, the light-emitting section 7A may be used in a state of being mounted on a substrate. This is explained with reference to FIG. 4. FIG. 4 shows how the light-emitting section 7A is used in a state of being mounted on a substrate, (a) showing a state where the light-emitting section 7A is mounted on a translucent substrate, (b) showing a state where the light-emitting section 7A is mounted on a light-reflecting substrate.

As shown in (a) of FIG. 4, the light-emitting section 7A may be used in a state of being mounted on a translucent substrate. In this case, the light-emitting section is a “transmissive” light-emitting section that emits the fluorescence L2 mainly through a facing surface thereof opposite to a laser beam irradiation surface thereof that is irradiated with the laser beam L1. As a material of the translucent substrate, glass, sapphire, or the like may be used. A highly thermally-conducting material such as sapphire is preferable, as it can efficiently dissipate heat generated in the phosphor irradiated with the laser beam L1. The fluorescence L2 is emitted from the light-emitting section 7A at various angles with respect to the translucent substrate.

Further, as shown in (b) of FIG. 4, the light-emitting section 7A may be used in a state of being mounted on a light-reflecting substrate. In this case, the fluorescent L2 is emitted mainly through the laser beam irradiation surface that is irradiated with the laser beam L1. Such a light-emitting section is herein referred to as a “reflective” light-emitting section. As a material of the light-reflecting substrate, metal, ceramics, or the like may be used. Using metal or ceramics makes it possible to efficiently dissipate heat generated in the phosphor. A preferred example of metal is a highly light-reflecting metal such as aluminum (Al) or silver (Ag). The fluorescence L2 is emitted from the light-emitting section 7A at various angles with respect to the light-reflecting substrate.

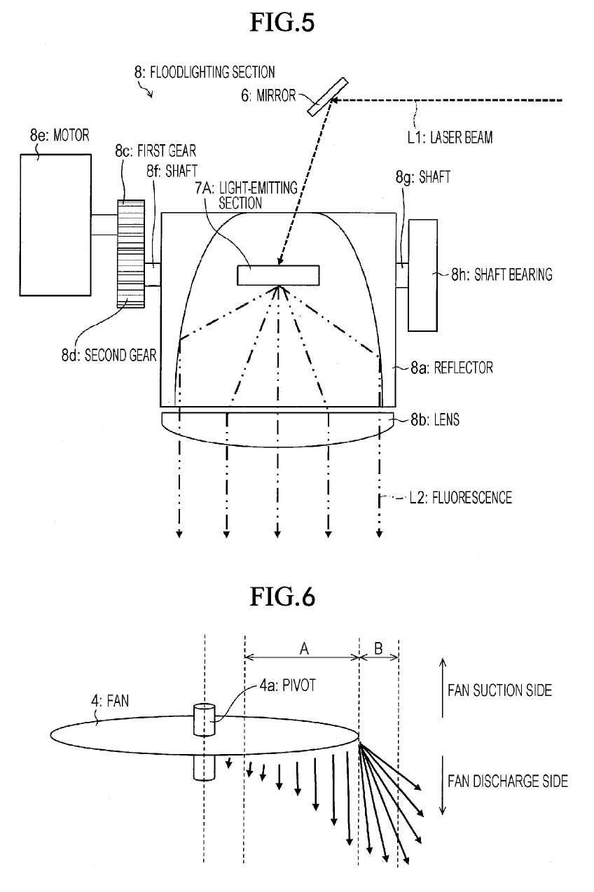

The floodlighting section 8 serves to radiate, toward an intended position, the fluorescence L2 radiated from the light-emitting section 7A. The floodlighting section 8 is described in detail with reference to FIG. 5. FIG. 5 is a schematic view showing a configuration of the floodlighting section 8.

As shown in FIG. 5, the floodlighting section 8 includes a reflector 8a, a lens 8b, a first gear 8c, a second gear 8d, a motor 8e, a shaft 8f, a shaft 8g, and a shaft bearing 8h.

The reflector 8a is a tubular member having openings at both ends, and includes, inside the tubular member, a reflecting mirror that reflects light. The fluorescence L2 radiated from the light-emitting section 7A enters the reflector 8a through one end of the reflector 8a, and is emitted through the other end of the reflector 8a with a portion of the fluorescence L2 being reflected by the reflecting mirror inside the reflector 8a.

The lens 8b is a lens through which the fluorescence L2 emitted from the reflector 8a is radiated outward at a desired orientation angle.

The first gear 8c is connected to the motor 8e, and the second gear 8d is connected to the reflector 8a. Further, the first gear 8c and the second gear 8d are connected to each other.

The motor 8e is a driving section for rotating the first gear 8c.

The shaft 8f is a pivot, connected to the reflector 8a and the second gear 8d, for transmitting rotative power of the second gear 8d to the reflector 8a. The shaft 8g is connected to the reflector 8a and the shaft bearing 8h. The shaft bearing 8h is a member for receiving an end of the shaft 8g opposite to an end of the shaft 8g connected to the reflector 8a. The shaft 8g and the shaft bearing 8h serve to stabilize driving of the reflector 8a.

The floodlighting section 8 uses the motor 8e to rotate the first gear 8c and thereby rotates the second gear 8d. Moreover, the transmission of the rotative power of the second gear 8d to the reflector 8a via the shaft 8f causes the fluorescent L2 radiated from the light-emitting section 7A to be radiated toward the intended position at varying angles of the reflector 8a. Although the unmanned aircraft 1A according to the present embodiment is configured to include the floodlighting section 8 that is driven by the motor 8e, an unmanned aircraft (moving body) of the present invention is not limited to this configuration. For example, the unmanned aircraft may be configured such that the floodlighting section is driven by using another movable scheme, or may be configured such that the reflector and the lens are fixed and are not driven.

(Installation Position of Laser Unit 10A)

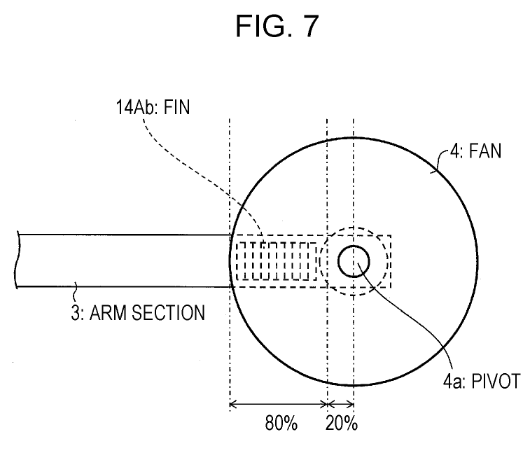

Next, the installation position of each of the laser units 10A in the unmanned aircraft 1A is described with reference to FIGS. 2, 6, and 7. FIG. 6 is an explanatory diagram showing the volume of air on a discharge side of a fan 4. FIG. 7 is a top view of the fan 4 and the area therearound in the unmanned aircraft 1A in a state where the fan 4 is rotating.

First, the volume of air on the discharge side of the fan 4 is described with reference to FIG. 6. As shown in FIG. 6, the volume of air that is blasted by the fan 4 is small in the vicinity of the pivot 4a of the fan 4 on the fan discharge side of the fan 4, and the volume of air that is blasted by the fan 4 becomes larger outward from the pivot. More specifically, in a region (region indicated by A in FIG. 6 (referred to as “region A”)) between a circle, centered at the pivot 4a of the fan 4, that has a 20% radius of the radius of the fan 4 and a circle, centered at the pivot 4a of the fan 4, that has a 100% radius of the radius of the fan 4, the volume of air that is blasted by the fan 4 is larger than in a region, centered the pivot 4a of the fan 4, that falls within 20% of the radius of the fan 4.

Accordingly, in the unmanned aircraft 1A, as shown in FIGS. 2 and 7, the laser unit 10A has its laser element 11A and its heat sink 14A provided within the region A. This makes it possible to efficiently cool down the heat sink 14A by utilizing a current of air that is generated from the fan 4 (air that is blasted by the fan 4). This results in making it possible to enhance heat dissipation efficiency of the laser element 11A, making it possible to cool down the laser element 11A.

Although the unmanned aircraft 1A is configured such that the heat sink 14A is wholly provided within the region A, this does not imply any limitation. For example, the unmanned aircraft 1A may be configured such that a part of the heat sink 14A is provided in a 20% region of the radius of the fan 4 centered at the pivot 4a of the fan 4. Note, however, that for improved heat dissipation efficiency of the laser element 11A, it is preferable that the heat sink 14A be provided within the region A.

(Features of Unmanned Aircraft 1A)

The unmanned aircraft 1A is an unmanned aircraft that gains propulsion through a fan 4, including a laser unit 10A that emits a laser beam L1, wherein the laser unit 10A has its heat dissipation efficiency enhanced by air that is blasted by the fan 4.

This feature makes it possible to radiate the laser beam L1 using the laser element 11A, which is smaller in size than an LED (light-emitting diode) element and an HID (high-intensity discharge) element. This results in making it possible to make the unmanned aircraft 1A lighter, making it possible to burn less cell (battery) power. Further, the undesirable decrease in light emission efficiency of a light element due to heat that is generated when the laser element radiates a laser beam can be addressed by preventing a decrease in light emission efficiency of the laser unit 10A by enhancing the heat dissipation efficiency of the laser unit 10A by cooling down the laser unit 10A with air that is blasted by the fan 4.

This brings about an effect of making it possible to provide an unmanned aircraft that is capable of suppressing a rise in temperature of the laser unit 10A and radiating high-luminance light from the laser unit 10A.

Further, the unmanned aircraft 1A includes a light-emitting section 7A that emits fluorescence L2 by being irradiated with the laser beam L1 emitted from the laser unit 10A. This makes it possible to emit a high-luminance fluorescence L2 from the light-emitting section 7A.

Further, the unmanned aircraft 1A uses a laser element 11A as a light-emitting element. This makes it possible to use a small floodlighting system to emit high-luminance light at a narrow angle. This makes it possible to radiate the fluorescence L2 toward a targeted place. Further, since the unmanned aircraft 1A can float in the air and move through the air, the fluorescence L2 can be radiated from a place where it is difficult to install a lighting fixture or a place that does not allow easy movement. Furthermore, when an object to be irradiated with the fluorescence L2 moves and an obstacle appears between the unmanned aircraft 1A and the object to be irradiated, the object to be irradiated can be irradiated with the fluorescence L2 by moving the unmanned aircraft 1A.

The unmanned aircraft 1A has an arm section 3 provided with the laser unit 10A. As such, the laser unit 10A is not configured to be provided in a housing 2 in which the light-emitting section 7A, a control section, a sensor, a camera, and the like are housed. This makes it possible to prevent the heat-generating members from being concentrated in the housing 2, making it possible to prevent heat that is generated from the laser unit 10A from affecting electronic equipment such as the light-emitting section 7A, the control section, the sensor, and the camera.

In the unmanned aircraft 1A, the laser unit 10A includes a heat sink 14A and dissipates heat via the heat sink 14A. This makes it possible to more efficiently cool down the laser unit 10A.

In the unmanned aircraft 1A, the fan 4 has its pivot 4a supported by the arm section 3 and provided within a region A. Since the volume of air that is blasted from the fan 4 is large in the region A, the laser unit 10A can be efficiently cooled down by providing the laser unit 10A in this region.

In the unmanned aircraft 1A, the light-emitting section 7A is provided in the housing 2, and the light-emitting section 7A is irradiated with the laser beam L1 radiated from the laser unit 10A with which each of a plurality of the arm sections 3 is provided. This makes it possible to radiate more high-luminance light by causing the light-emitting section 7A provided in the housing 2 to emit the laser beams L1 radiated from a plurality of the laser units 10A.

In the unmanned aircraft 1A, the laser beam L1 emitted from the laser unit 10A is radiated to the light-emitting section 7A via the interior of the arm section 3. This prevents the laser beam L1 emitted from the laser unit 10A from leaking out of the unmanned aircraft 1A, thus making it possible to give improved safety.

Although the unmanned aircraft 1A is configured such that the laser unit 10A includes the heat sink 14A, an unmanned aircraft (moving body) of the present invention is not limited to this configuration. For example, an unmanned aircraft (moving body) of the present invention may be configured such that the arm section 3 has an opening provided above a region thereof where the laser element 11A is provided and the laser element 11A is directly cooled down by air that is blasted from the fan 4. Note, however, that the inclusion of the heat sink 14A by the laser unit 10A makes it possible to efficiently dissipate heat from the laser element 11A.

<Modification>

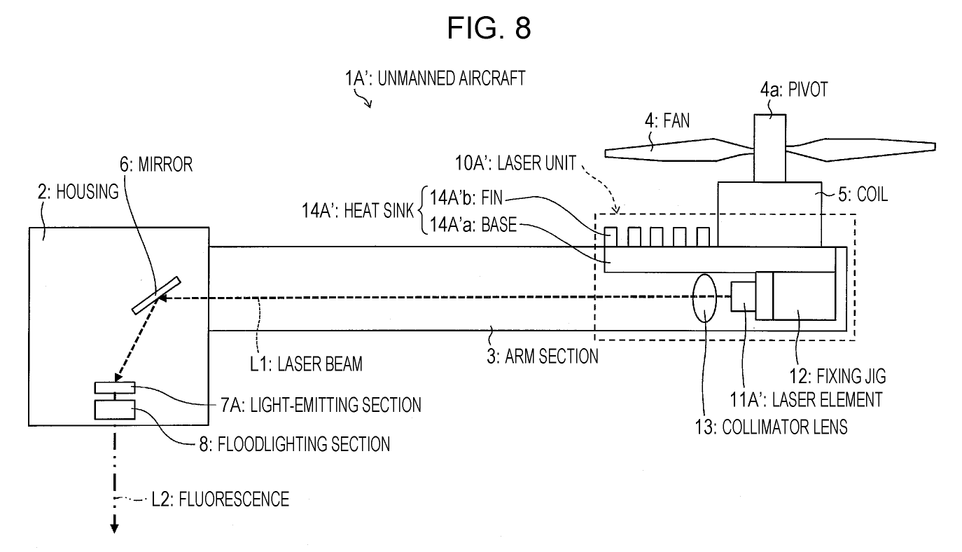

An unmanned aircraft 1A′ according to a modification of the unmanned aircraft 1A according to Embodiment 1 of the present invention is described with reference to FIG. 8. FIG. 8 is a cross-sectional view showing a configuration of the unmanned aircraft 1A′. For convenience of explanation, members having the same functions as those described in Embodiment 1 are given the same signs and, as such, are not described here. In the unmanned aircraft 1A′, the position where a laser element 11A′ of a laser unit 10A′ is provided differs from the position in the unmanned aircraft 1A where the laser element 11A is provided.

As shown in FIG. 8, the unmanned aircraft 1A′ includes a laser unit 10A′. The laser unit 10A′ includes a laser element 11A′ and a heat sink 14A′.

The laser element 11A′ is provided in a part of the interior of the arm section 3 located immediately below the fan 4 (i.e. in a region, centered at the pivot 4a of the fan 4, that falls within 20% of the radius of the fan 4).

The heat sink 14A′ includes a base 14A′a and fins 14A′b.

The base 14A′a is a flat-plate member with the laser element 11A′ connected to one surface thereof and with the plurality of fins 14A′b formed on the other surface thereof.

The fins 14A′b are radiator plates protruding from the base 14A′a toward the fan 4.

In the unmanned aircraft 1A′, the base 14A′a is provided inside the arm section 3. Further, the arm section 3 has an opening (not illustrated) provided above a region thereof where the base 14A′a is provided, and the fins 14A′b protrude to the outside of the arm section 3 via the opening. The fins 14A′b are provided within the region A. This results in making it possible to efficiently cool down the heat sink 14A′ via the fins 14A′b by utilizing a current of air that is generated from the fan 4 (air that is blasted by the fan 4). This results in making it possible to effectively dissipate heat generated from the laser element 11A′.

### Embodiment 2

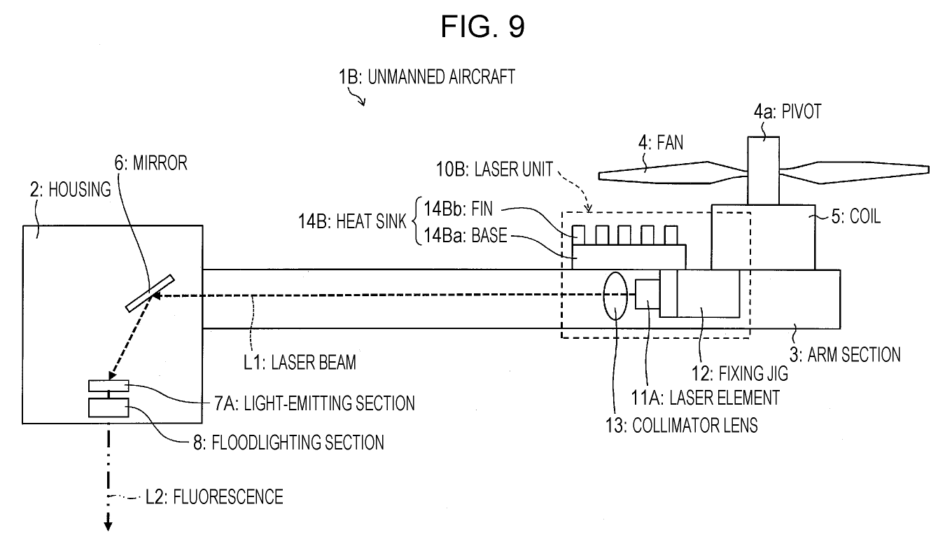

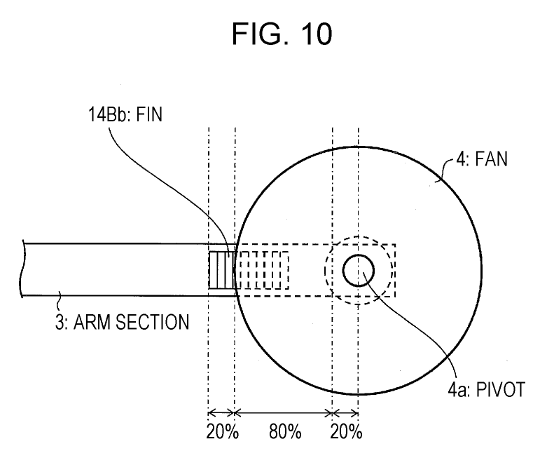

Another embodiment of the present invention is described below with reference to FIGS. 9 and 10. For convenience of explanation, members having the same functions as those described in the foregoing embodiment are given the same signs and, as such, are not described here.

An unmanned aircraft 1B according to the present embodiment differs from the unmanned aircraft 1A according to Embodiment 1 in terms of the position where a heat sink 14B of a laser unit 10B is provided.

A configuration of the unmanned aircraft 1B is described with reference to FIGS. 9 and 10. FIG. 9 is a cross-sectional view showing a configuration of the unmanned aircraft 1B. FIG. 10 is a top view of a fan 4 and the area therearound in the unmanned aircraft 1B in a state where the fan 4 is rotating.

As shown in FIGS. 9 and 10, a laser unit 10B of the unmanned aircraft 1B includes a heat sink 14B. The heat sink 14B includes a base 14Ba and fins 14Bb.

In the unmanned aircraft 1B, a part of the base 14Ba of the heat sink 14B and some of the fins 14Bb are provided within the region A, and another part of the base 14Ba of the heat sink 14B and others of the fins 14Bb are provided between a circle, centered at the pivot 4a of the fan 4, that has a 100% radius of the radius of the fan 4 and a circle, centered at the pivot 4a of the fan 4, that has a 120% radius of the radius of the fan 4.

Note here that, as shown in FIG. 6, the volume of air that is blasted by the fan is large in a region (region indicated by B in FIG. 6 (referred to as “region B”)) between the circle, centered at the pivot 4a of the fan 4, that has a 100% radius of the radius of the fan 4 and the circle, centered at the pivot 4a of the fan 4, that has a 120% radius of the radius of the fan 4.

Accordingly, by providing a part of the base 14Ba of the heat sink 14B and some of the fins 14Bb within the region B, the heat sink 14B can be efficiently cooled down by air that is blasted by the fan 4. This results in making it possible to effectively dissipate heat generated from the laser element A of the laser unit 10B.

<Modification>

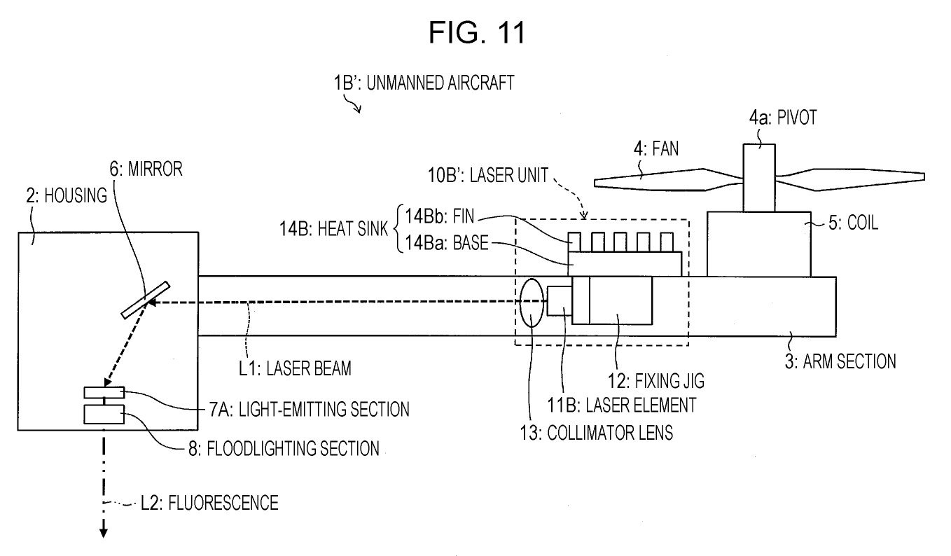

An unmanned aircraft 1B′ according to a modification of the unmanned aircraft 1B according to Embodiment 2 of the present invention is described with reference to FIG. 11. FIG. 11 is a cross-sectional view showing a configuration of the unmanned aircraft 1B′. For convenience of explanation, members having the same functions as those described in Embodiments 1 and 2 are given the same signs and, as such, are not described here. In the unmanned aircraft 1B′, the position where a laser element 11B of a laser unit 10B′ is provided differs from the position in the unmanned aircraft 1B where the laser element 11A of the laser unit 10B is provided.

As shown in FIG. 11, the unmanned aircraft 1B′ includes a laser unit 10B′. The laser unit 10B′ includes a laser element 11B.

The laser element 11B is provided within the region B. The laser element 11B is connected to the base 14Ba of the heat sink 14B.

Since the laser element 11B is thus connected to the heat sink 14B even in a case where the laser element 11B is provided within the region B, heat generated from the laser element 11B can be effectively dissipated via the heat sink 14B.

### Embodiment 3

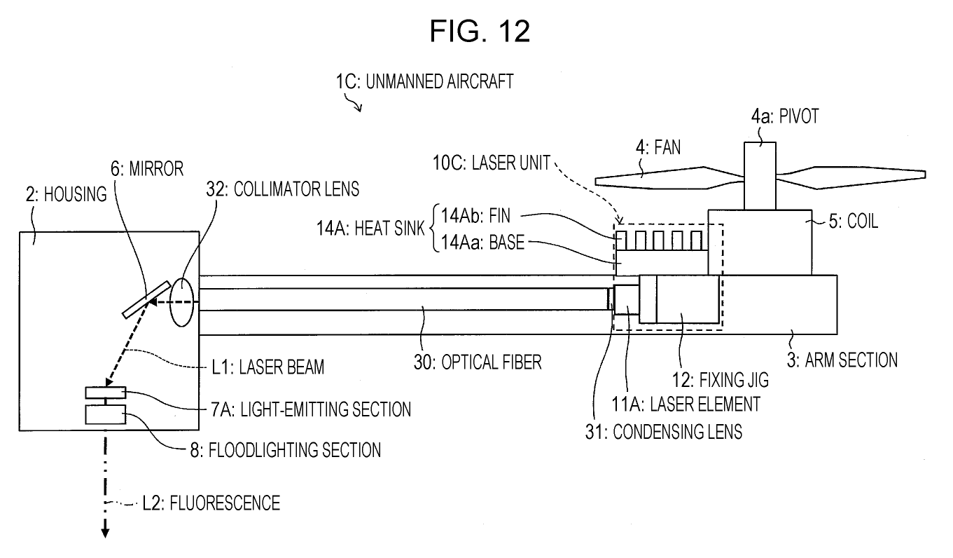

Another embodiment of the present invention is described below with reference to FIG. 12. For convenience of explanation, members having the same functions as those described in the foregoing embodiments are given the same signs and, as such, are not described here.

An unmanned aircraft 1C according to the present embodiment differs from the unmanned aircraft 1A according to Embodiment 1 in that a laser beam L1 emitted from a laser unit 10C is radiated to the light-emitting section 7A via an optical fiber 30.

A configuration of the unmanned aircraft 1C is described with reference to FIG. 12. FIG. 12 is a cross-sectional view showing a configuration of the unmanned aircraft 1C.

As shown in FIG. 12, the unmanned aircraft 1C includes a laser unit 10C, an optical fiber 30, a condensing lens 31, and a collimator lens 32.

The laser unit 10C includes a laser element 11A, a fixing jig 12, and a heat sink 14A, and emits a laser beam L1.

The condensing lens 31 is a lens for causing the laser beam L1 emitted from the laser unit 10C to enter the optical fiber 30. The condensing lens 31 is provided next to an exit surface of the laser element 11A of the laser unit 10C.

The optical fiber 30 is a light guiding member, provided inside the arm section 3, for guiding, toward the mirror 6, the laser beam L1 emitted from the laser unit 10C and having entered through the condensing lens 31. The optical fiber 30 has a two-layer structure in which a central core is covered with a clad that is lower in refractive index than the core. The core is composed mainly of quartz glass (silicon oxide), which is almost free from an absorption loss of the laser beam L1. The clad is composed mainly of quartz glass or a synthetic resin material that are lower in refractive index than the core. For example, the optical fiber 30 is a quartz optical fiber whose core has a diameter of 200 μm, whose clad has a diameter of 800 μm, and whose numerical aperture NA is 0.1. The structure, size, and material of the optical fiber 30 are not limited to those mentioned above. A cross-section perpendicular to a long axis direction of the optical fiber 30 may be rectangular, or such a cross-section of the core may be circular.

The collimator lens 32 is a lens for turning the laser beam L1 emitted from the optical fiber 30 into a parallel ray.

As noted above, in the unmanned aircraft 1C, the laser beam L1 emitted from the laser unit 10C is radiated to the light-emitting section 7A via the optical fiber 30. This prevents the laser beam L1 from leaking out of the unmanned aircraft 1C and provide imperviousness to vibration, thus making it possible to give improved safety.

Further, in the unmanned aircraft 1C, the optical fiber 30 is provided inside the arm section 3. This prevents the laser beam L1 from leaking out even in a case where the arm section 3 is damaged by impact or the like from outside, thus making it possible to give further improved safety.

<Modification>

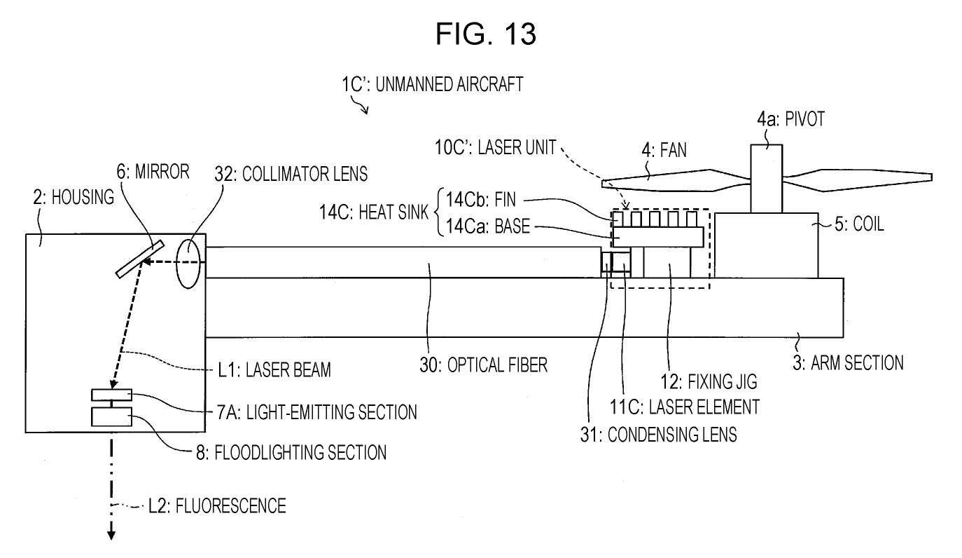

An unmanned aircraft 1C′ according to a modification of the unmanned aircraft 1C according to Embodiment 3 of the present invention is described with reference to FIG. 13. FIG. 13 is a cross-sectional view showing a configuration of the unmanned aircraft 1C′. For convenience of explanation, members having the same functions as those described in Embodiments 1 to 3 are given the same signs and, as such, are not described here. In the unmanned aircraft 1C′, the position where a laser unit 10C′ is provided differs from the position in the unmanned aircraft 1C where the laser unit 10C is provided.

As shown in FIG. 13, the unmanned aircraft 1C′ includes a laser unit 10C′.

The laser unit 10C′ includes a laser element 11C, a fixing jig 12, and a heat sink 14C.

In the unmanned aircraft 1C′, the laser element 11C and the optical fiber 30 are provided on top of the arm section 30.

A laser beam L1 emitted from the laser unit 10C is caused by the condensing lens 31 to enter the optical fiber 30. Having entered the optical fiber 30, the laser beam L1 is guided through the optical fiber 30 and radiated to the housing 2. This results in preventing the laser beam L1 from leaking out of the unmanned aircraft 1C′, thus making it possible to give improved safety. This also provides high vibration durability.

Although the unmanned aircraft 1C′ is configured such that the optical fiber 30 is wholly provided on top of the arm section 3, an unmanned aircraft (moving body) of the present invention is not limited to this configuration. For example, an unmanned aircraft (moving body) of the present invention may be configured such that the arm section 3 is provided with an opening through which an optical fiber is introduced into the arm section 3.

### Embodiment 4

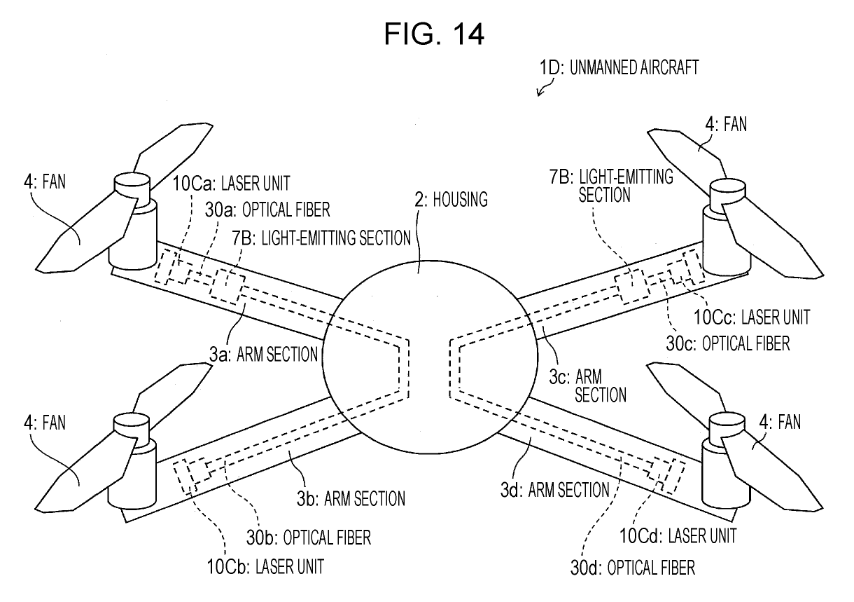

Another embodiment of the present invention is described below with reference to FIGS. 14 to 16. For convenience of explanation, members having the same functions as those described in the foregoing embodiments are given the same signs and, as such, are not described here.

An unmanned aircraft 1D according to the present embodiment differs from the unmanned aircraft 1A according to Embodiment 1 in terms of the position where a light-emitting section is provided.

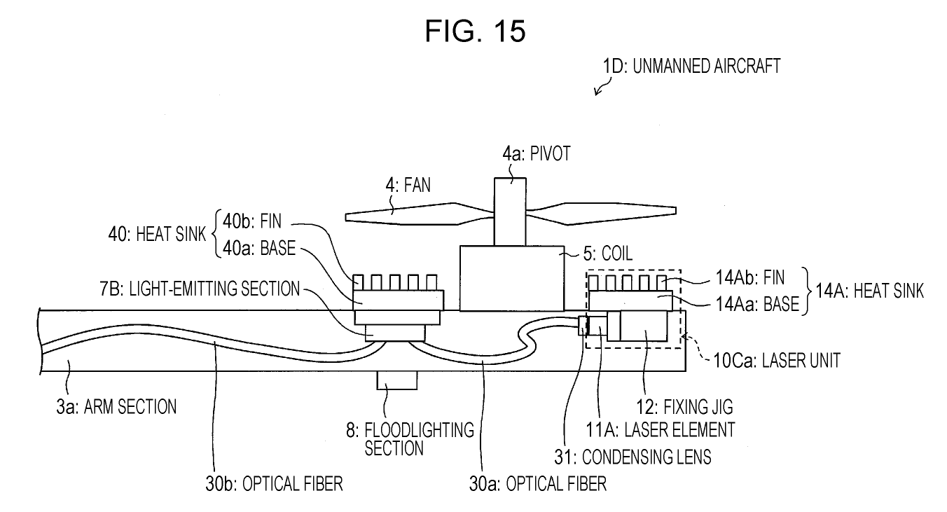

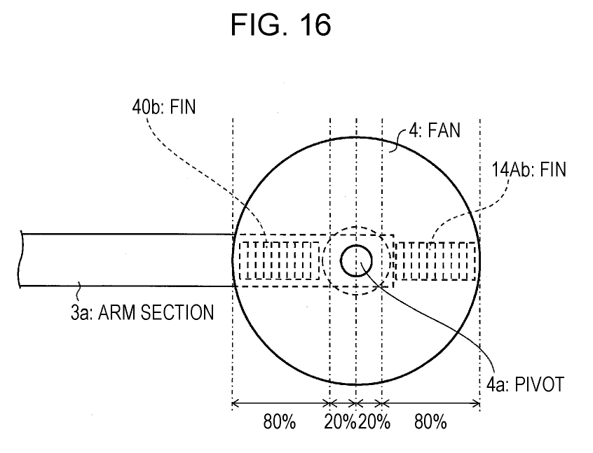

A configuration of the unmanned aircraft 1D is described with reference to FIGS. 14 to 16. FIG. 14 is a schematic view showing an overall configuration of the unmanned aircraft 1D. FIG. 15 is a cross-sectional view showing a configuration of the unmanned aircraft 1D. FIG. 16 is a top view of a fan 4 and the area therearound in the unmanned aircraft 1D. It should be noted that FIGS. 14 to 16 refer to the four arm sections as “arm sections 3a to 3d” in order to distinguish them from one another. Further, laser units and optical fibers that correspond to the arm sections 3a to 3d are referred to as “laser units 10Ca to 10Cd” and “optical fibers 30a to 30d”, respectively.

As shown in FIGS. 14 and 15, the unmanned aircraft 1D includes arms sections 3a to 3d, laser units 10Ca to 10Cd, optical fibers 30a to 30d, two light-emitting sections 7B, and two floodlighting sections 8.

The two light-emitting sections 7B are provided in inner upper parts of the arm sections 3a and 3c, respectively.

The arm sections 3a to 3d are provided with the laser units 10Ca to 10Cd, respectively. Laser beams emitted from the laser units 10Ca to 10Cd are guided by the optical fibers 30a to 30d, respectively.

Each of the floodlighting sections 8 serves to radiate, toward an intended position, fluorescence radiated from the corresponding one of the light-emitting sections 7B. The floodlighting section 8 is provided on an outer part of the arm section 3a or 3c so as to be located below the light-emitting section 7B. Although not illustrated, the arm section 3a has an opening provided in a region thereof where the floodlighting section 8 is provided, so that light radiated from the light-emitting section 7B can enter the floodlighting section 8 via the opening.

The light-emitting section 7B provided in the arm section 3a is irradiated with a laser beam emitted from the laser unit 10Ca and guided by the optical fiber 30a and a laser beam emitted from the laser unit 10Cb and guided by the optical fiber 30b and, upon receiving these laser beams, converts the wavelengths of the laser beams to emit fluorescence. Similarly, the light-emitting section 7B provided in the arm section 3c is irradiated with a laser beam emitted from the laser unit 10Cc and guided by the optical fiber 30c and a laser beam emitted from the laser unit 10Cd and guided by the optical fiber 30d and, upon receiving these laser beams, converts the wavelengths of the laser beams to emit fluorescence. The fluorescence emitted from the light-emitting section 7B provided in the arm section 3a and the fluorescence emitted from the light-emitting section 7B provided in the arm section 3c are radiated toward the intended position by the floodlighting sections 8 provided below the respective light-emitting sections 7B.

Incidentally, the light-emitting sections 7B generate heat in emitting fluorescence. This undesirably leads to a rise in temperature of the light-emitting sections 7B, undesirably causing a decrease in wavelength conversion efficiency. To address this problem, the unmanned aircraft 1D is configured such that, as shown in FIGS. 15 and 16, each of the light-emitting sections 7B includes a heat sink 40. The heat sink 40 serves to dissipate heat generated by the light-emitting section 7B emitting fluorescence. For this reason, it is preferable that the heat sink 40 be made of a highly thermally-conducting metal material such as aluminum. The heat sink 40 includes a base 40a and fins 40b.

The base 40a is a flat-plate member with the floodlighting section 8 connected to a lower surface thereof and with the plurality of fins 40b formed on an upper surface thereof.

The fins 40b are radiator plates protruding from the upper surface of the base 40a toward the fan 4, and enhance heat dissipation efficiency of the heat sink 40 by increasing an area of contact of the heat sink 40 with the atmosphere.

The heat sink 40 is provided on top of an outer part of the arm section 3. More specifically, the base 40a, which is connected to the light-emitting section 7B, is placed on the outer part of the arm section 3, and the fins 40b protrude upward from the base 40a. Although not illustrated, the arm section 3 has an opening formed in a part thereof where the light-emitting section 7B and the base 40a are connected to each other. This allows the light-emitting section 7B and the base 40a to make contact with each other. As shown in FIG. 16, the heat sink 14A heat sink 40 is provided within the aforementioned region A. This makes it possible to efficiently cool down the heat sink 40 by utilizing a current of air that is generated from the fan 4 (air that is blasted by the fan 4). This results in efficiently dissipating heat generated from the light-emitting section 7B, making it possible to effectively dissipate heat from the light-emitting section 7B.

As noted above, in the unmanned aircraft 1D according to the present embodiment, the light-emitting sections 7B are provided in the arm sections 3a and 3c, respectively. According to this configuration, the light-emitting sections 7B are not configured to be provided in a housing 2 in which a control section, a sensor, a camera, and the like are housed. This makes it possible to prevent the heat-generating members from being concentrated in the housing 2, making it possible to prevent heat that is generated from the light-emitting sections 7B from affecting electronic equipment such as the control section, the sensor, and the camera.

Further, in the unmanned aircraft 1D, each of the light-emitting sections 7B includes a heat sink 40, and the heat sink 40 is provided within the region A. This makes it possible to efficiently cool down the heat sink 40 with air that is blasted by the fan 4. This results in efficiently dissipating heat generated from the light-emitting section 7B, making it possible to effectively dissipating heat from the light-emitting section 7B. This makes it possible to prevent a decrease in wavelength conversion efficiency of the light-emitting section 7B.

Although the unmanned aircraft 1E is configured such that two light-emitting sections 7B are provided, an unmanned aircraft (moving body) of the present invention is not limited to this configuration. For example, an unmanned aircraft (moving body) of the present invention may be configured such that a light-emitting section 7B is provided only in the arm section 3a and laser beams emitted from the laser units 10Ca to 10Cd are guided by the optical fibers 30a to 30d, respectively, to be radiated to the light-emitting section 7B provided in the arm section 3a.

### Embodiment 5

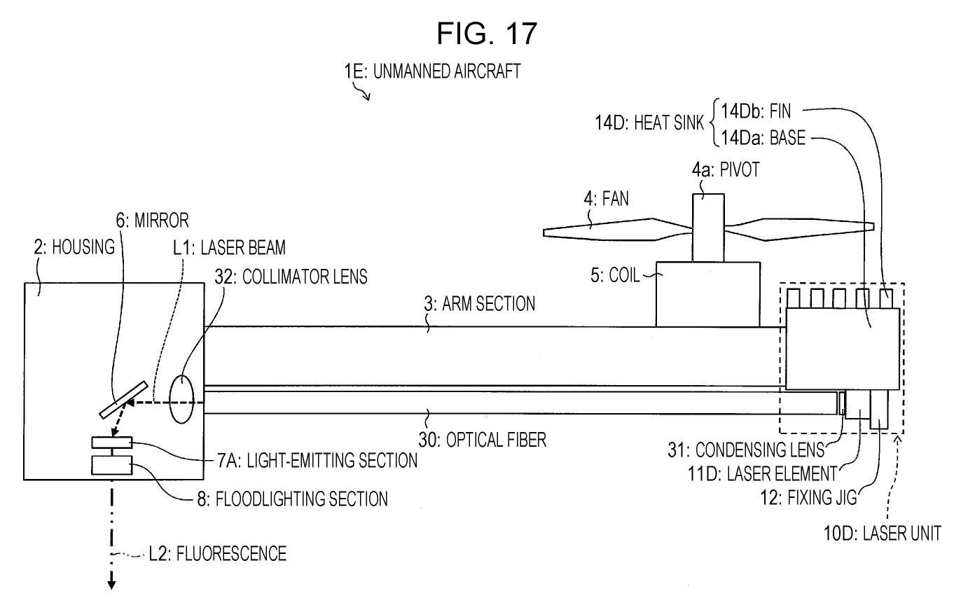

Another embodiment of the present invention is described below with reference to FIG. 17. For convenience of explanation, members having the same functions as those described in the foregoing embodiments are given the same signs and, as such, are not described here.

An unmanned aircraft 1E according to the present embodiment differs from the unmanned aircraft 1A according to Embodiment 1 in that a laser unit 10D is detachable.

A configuration of the unmanned aircraft 1E is described with reference to FIG. 17. FIG. 17 is a cross-sectional view showing a configuration of the unmanned aircraft 1E.

As shown in FIG. 17, the unmanned aircraft 1E includes a laser unit 10D.

The laser unit 10D is detachably attached to an end of the arm section 3 opposite to the housing 2. Examples of methods for detachably attaching the laser unit 10D to the arm section 3 include, but are not particularly limited to, a method for fixing the laser unit 10D to the arm section 3 using a screw, a method for providing a fitting member for fitting the laser unit 10D into the arm section 3, and similar methods.

The laser unit 10D includes a laser element 11D, a fixing jig 12, and a heat sink 14D. The laser element 11D is provided below the arm section 3 in a vertical direction, and a laser beam L1 emitted from the laser element 11D is guided toward the light-emitting section 7A via an optical fiber 30 provided below the arm section 3.

The heat sink 14D includes a base 14Da and fins 14Db. In the unmanned aircraft 1D, a part of the base 14Da and some of the fins 14Db are provided within the region A, and another part of the base 14Da and others of the fins 14Db are provided within the region B. This makes it possible to efficiently cool down the heat sink 14D with air that is blasted by the fan 4. This results in making it possible to effectively dissipating heat generated from the laser element 11D of the laser unit 10D.

Thus, the unmanned aircraft 1E is configured such that the laser unit 10D is detachable. This makes it possible to easily replace the laser unit 10D in the event of a fault in the laser unit 10D.

### Embodiment 6

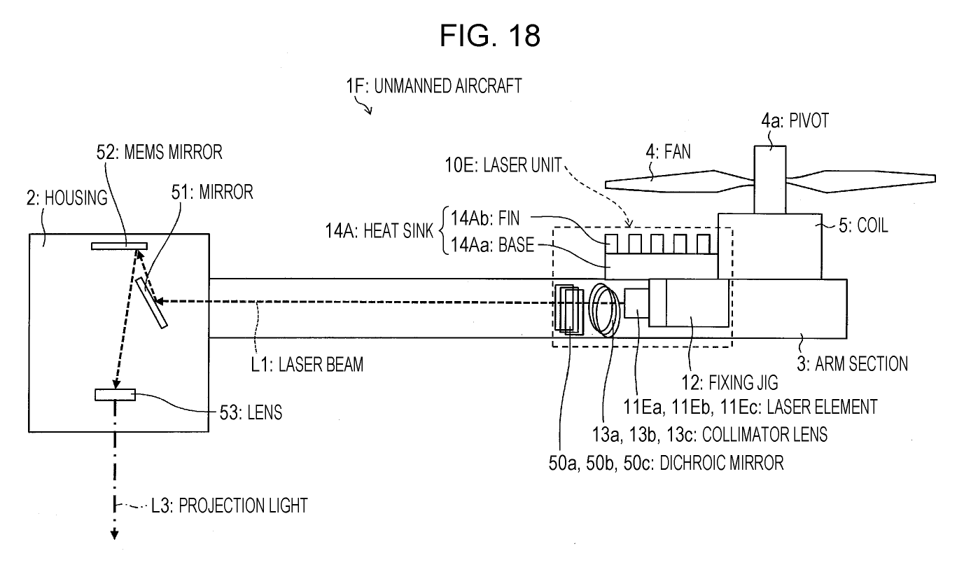

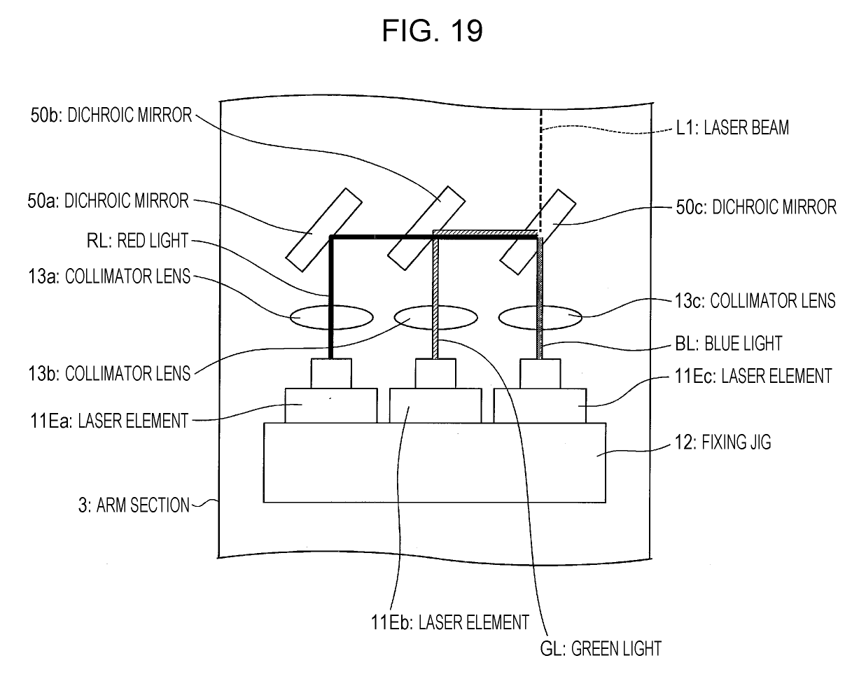

Another embodiment of the present invention is described below with reference to FIGS. 18 and 19. For convenience of explanation, members having the same functions as those described in the foregoing embodiments are given the same signs and, as such, are not described here.

An unmanned aircraft 1F according to the present embodiment has a projection function that involves the use of a laser beam L1.

A configuration of the unmanned aircraft 1F is described with reference to FIGS. 18 and 19. FIG. 18 is a cross-sectional view showing a configuration of the unmanned aircraft 1F. FIG. 19 is an explanatory diagram showing a method for merging laser beams that are emitted from a laser unit 10E.

As shown in FIG. 18, the unmanned aircraft 1F includes a laser unit 10E, a mirror 51, a MEMS (microelectromechanical system) mirror (projection section) 52, and a lens 53.

The laser unit 10E includes laser elements 11Ea to 11Ec, collimator lenses 13a to 13c serving as optical components, and dichroic mirrors 50a to 50c.

The laser elements 11Ea to 11Ec are laser light-emitting elements (light sources) that emit laser beams of red light RL, green light GL, and blue light BL differing in wavelength from one another.

The collimator lenses 13a to 13c are lenses for turning laser beams L1 emitted from the laser elements 11Ea to 11Ec into parallel rays, respectively.

The dichroic mirrors 50a to 50c are mirrors that reflect or transmit only particular wavelengths, respectively. Specifically, as shown in FIG. 19, the dichroic mirror 50a reflects the red light RL. The dichroic mirror 50b reflects the green light GL and transmits the red light RL. The dichroic mirror 50c transmits the blue light BL and reflects the green light GL and the red light RL. This causes the laser beams emitted from the laser elements 11Ea to 11Ec to be combined into a single laser beam L1 that is emitted toward the housing 2.

In the laser unit 10E, the laser elements 11Ea to 11Ec, the collimator lenses 13a to 13c, and the dichroic mirrors 50a to 50c are fixed to a support pedestal (not illustrated) with their installation positions adjusted. However, a laser unit of the present invention is not limited to this. For example, the laser element 11Ea, the collimator lens 13a, and the dichroic mirror 50a may be integrally configured. Further, the number of laser elements that a laser unit includes may be larger than 3, and the luminance of projection light L3 that is emitted from the unmanned aircraft 1F can be increased by increasing the number of laser elements.

The mirror 51 is a mirror for reflecting the laser beam L1 toward the MEMS mirror 52. Although the unmanned aircraft 1F uses one mirror to reflect the laser beam L1 toward the MEMS mirror 52, an unmanned aircraft (moving body) of the present invention is not limited to this. For example, a plurality of mirrors may be used to reflect the laser beam L1 toward the MEMS mirror 52. This allows the laser beam L1 to be incident on the MEMS mirror 52 at a moderate angle of incidence.

The MEMS mirror 52 is a mirror that reflects the incoming laser beam L1 and emits the projection light L3. Operation of the MEMS mirror 52 is controlled by a MEMS driver (not illustrated) so that the MEMS mirror 52 can vary its tilt. The MEMS driver controls the MEMS mirror 52 in synchronization with a signal from a laser driver (not illustrated). The laser driver contains an antenna that receives a radio signal (e.g. Wi-Fi (Wireless Fidelity, registered trademark)). The laser driver turns on and off a laser on the basis of image or video information transmitted by means of a radio signal, and the MEMS driver controls operation of the MEMS mirror 52 in synchronization with a signal from the laser driver, whereby the projection light L3 is radiated from the MEMS mirror 52.

The lens 53 is a lens for emitting outward the projection light L3 emitted by the MEMS mirror 52. It is preferable that the lens 53 have a function of correcting a distortion or the like in an image or video projected by the projection light L3 emitted from the MEMS mirror 52. This makes it possible to project projection light L3 of an image or video that is almost free of a distortion or the like.

In the unmanned aircraft 1F, the laser beams L1 incident on the dichroic mirrors 50a to 50c are combined into a single laser beam L1 by being each reflected or transmitted by the dichroic mirrors 50a to 50c, and the laser beam L1 is emitted toward the housing 2. Having entered the housing 2, the laser beam L1 is reflected toward the MEMS mirror 52 by the mirror 51. Then, the MEMS driver controls driving of the MEMS mirror 52 in synchronization with a signal from a laser driver that can receive a radio signal, whereby projection light L3 of an image or video transmitted by means of a radio signal is radiated from the MEMS mirror 52. The projection light L3 emitted by the MEMS mirror 52 is emitted outward through the lens 53 and radiated to a screen, whereby a picture such as an image or a video can be projected onto the screen.

Further, the unmanned aircraft 1F includes the laser elements 11Ea to 11Ec. This results in making it possible to achieve focus-free, thus providing such a feature that the picture to be projected is not affected by the height of floating.

As noted above, the unmanned aircraft 1F includes the MEMS mirror 52, which shows a picture by merging and radiating the red light RL, the green light RL, and the blue light BL emitted from the laser elements 11Ea to 11Ec, respectively.

This configuration uses the laser elements 11Ea to 11Ec, which are smaller in size than LED elements and HID elements and emit laser beams. This results in making it possible to project a bright picture. This also results in making it possible to make the unmanned aircraft 1F lighter, thus making it possible to burn less cell (battery) power. Further, the undesirable decrease in light emission efficiency of the light elements 11Ea to 11Ec due to heat that is generated when the light elements 11Ea to 11Ec radiate laser beams can be addressed by preventing a decrease in light emission efficiency of the light elements 11Ea to 11Ec by cooling down the light elements 11Ea to 11Ec with air that is blasted by the fan 4.

Further, since the unmanned aircraft 1F can project a picture while floating in the air, the picture can be projected from a place where installation has conventionally been difficult. Further, since an image or a video is projected onto a screen using a laser beam L1 emitted from the laser unit 10E, a bright picture can be projected onto the screen.

### Embodiment 7

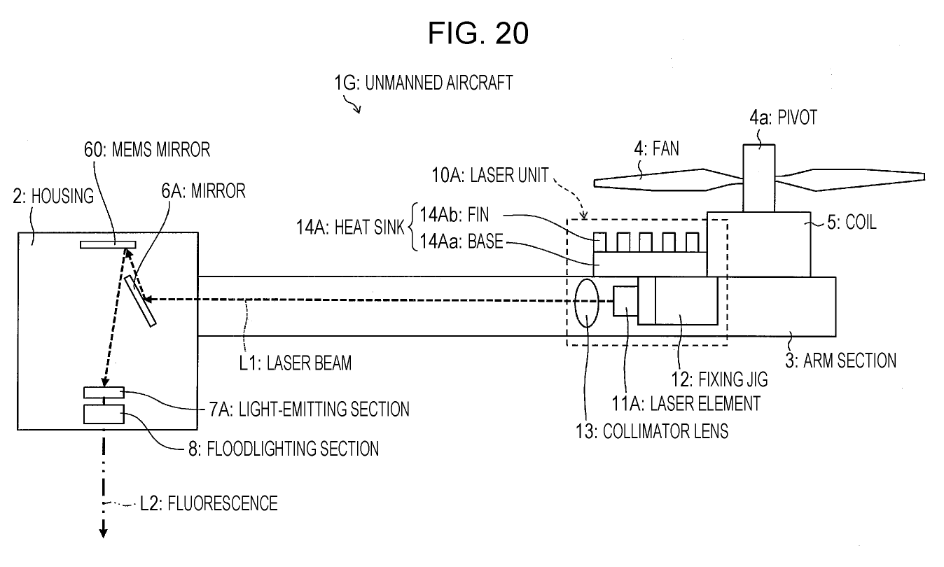

Another embodiment of the present invention is described below with reference to FIG. 20. For convenience of explanation, members having the same functions as those described in the foregoing embodiments are given the same signs and, as such, are not described here.

An unmanned aircraft 1G according to the present embodiment differs from the unmanned aircraft 1A according to Embodiment 1 in that the unmanned aircraft 1G includes a MEMS mirror.

A configuration of the unmanned aircraft 1G is described with reference to FIG. 20. FIG. 20 is a cross-sectional view showing a configuration of the unmanned aircraft 1G.

As shown in FIG. 20, the unmanned aircraft 1G includes a mirror 6A and a MEMS mirror 60.

The mirror 6A is a mirror, provided inside the housing 2, that serves to cause a laser beam L1 emitted from the laser unit 10A to be reflected toward the MEMS mirror 60 after having arrived at the interior of the housing 2.

The MEMS mirror 60 is a mirror for reflecting, toward the light-emitting section 7A, the laser beam L1 coming from the mirror 6A, and the tilt of the MEMS mirror 60 with respect to the laser beam L1 is controlled by a MEMS driver (not illustrated). That is, a laser driver (not illustrated) turns on and off a laser on the basis of information represented by a signal from an outside source, and the MEMS driver (not illustrated) controls the tilt of the MEMS mirror 60 with respect to the laser beam L1 in synchronization with a signal from the laser driver, whereby the angle of reflection of the laser beam L1 that is reflected by the MEMS mirror 60 is controlled.

In the unmanned aircraft 1G, the laser beam L1 emitted from the laser unit 10A is made incident on the MEMS mirror 60 via the mirror 6A. The laser beam L1 incident on the MEMS mirror 60 is reflected by the MEMS mirror 60 to be incident on the light-emitting section 7A, and is converted by the light-emitting section 7A into fluorescence L2. The fluorescence L2, into which the laser beam L1 has been converted by the light-emitting section 7A, is radiated outward by the floodlighting section 8.

Moreover, as mentioned above, the MEMS mirror 62 has its tilt controlled by the MEMS driver in synchronization with a signal from the laser driver. For example, a physical object identified by a camera (not illustrated) attached to the unmanned aircraft 1G or a physical object identified by an infrared radar (not illustrated) attached to the unmanned aircraft 1G is transmitted as a signal to the laser driver, the laser driver turns on and off the laser on the basis of the signal, and the MEMS driver controls the tilt of the MEMS mirror 60 with respect to the laser beam L1 in synchronization with a signal from the laser driver. This makes the unmanned aircraft 1G a lighting apparatus that can irradiate only a region that needs to be irradiated with the fluorescence L2. That is, the unmanned aircraft 1G is an orientation-variable lighting apparatus that is capable of illuminating only a particular physical object or not illuminating a particular physical object.

### Embodiment 8

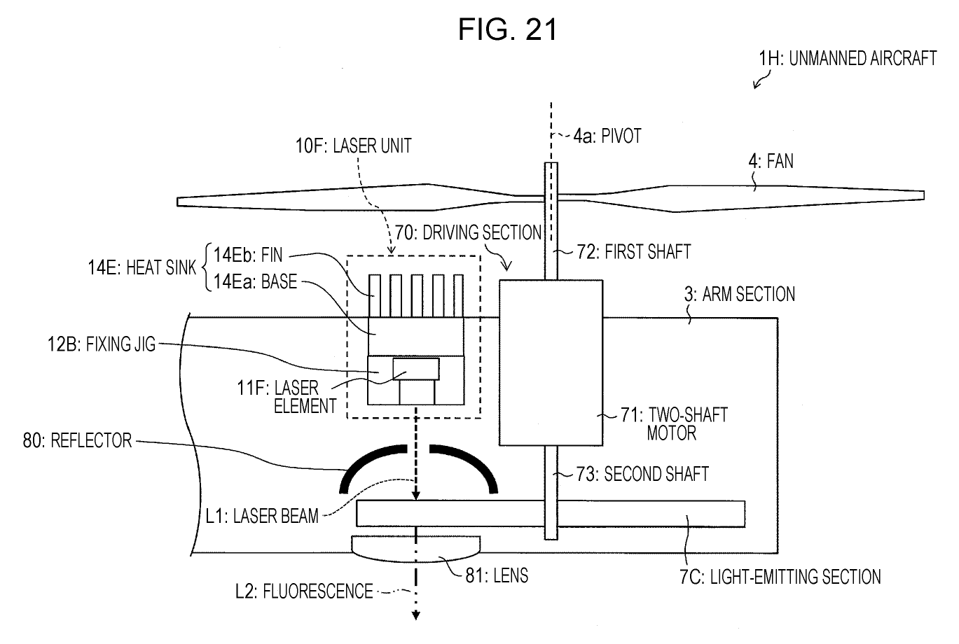

Another embodiment of the present invention is described below with reference to FIG. 21. For convenience of explanation, members having the same functions as those described in the foregoing embodiments are given the same signs and, as such, are not described here.

A configuration of an unmanned aircraft 1H according to the present embodiment is described with reference to FIG. 21. FIG. 21 is a cross-sectional view showing a configuration of a fan 4 and the area therearound of the unmanned aircraft 1H.

As shown in FIG. 21, the unmanned aircraft 1H includes a driving section 70, a laser unit 10F, a light-emitting section 7C, a reflector 80, and a lens 81 instead of the coil 5, laser unit 10A, mirror 6, and light-emitting section 7A of the unmanned aircraft 1A according to Embodiment 1.

The driving section 70 includes a two-shaft motor 71, a first shaft 72, and a second shaft 73.

The two-shaft motor 71 is a motor for causing the first shaft 72, connected to an upper part of the two-shaft motor 71, and the second shaft 73, connected to a lower part of the two-shaft motor 71, to rotate on a vertical axis of rotation.

The first shaft 72, which has its upper part connected through the pivot 4a of the fan 4, is a shaft for rotating the fan 4 by being rotated by the two-shaft motor 71.

The second shaft 73, which has its lower part connected through the after-mentioned pivot of the light-emitting section 7C, is a shaft for rotating the light-emitting section 7C by being rotated by the two-shaft motor 71.

The laser unit 10F includes a laser element 11F, a fixing jig 12B, and a heat sink 14E.

The laser element 11F is fixed to the after-mentioned base 14Ea of the heat sink 14E by the fixing jig 12B. The laser element 11F is disposed inside the arm section 3, and radiates a laser beam L1 downward toward the after-mentioned light-emitting section 7C.

The heat sink 14E serves to dissipate heat generated by the laser element 11F radiating the laser beam L1. The heat sink 14E includes the base 14Ea and fins 14Eb. The base 14Ea is installed inside the arm section 3. The fins 14Eb protrudes from an upper surface of the base 14Ea toward the fan 4. The arm section 3 has a hole (not illustrated) through which the fins 14Eb are passed.

The light-emitting section 7C serves to emit fluorescence L2 by converting the wavelength of the laser beam L1 radiated from the laser unit 10F (laser element 11F). The light-emitting section 7C is provided below the laser element 11F inside the arm section 3. The light-emitting section 7C is in the shape of a disk with the second shaft 73 passed through the center of the disk. The light-emitting section 7C rotates on the center of the disk as an axis of rotation in response to a driving force transmitted from the two-shaft motor 71 via the second shaft 73.

The light-emitting section 7C is formed by applying a phosphor to a translucent substrate such as glass or sapphire. The phosphor used may be a phosphor described in Embodiment 1. The light-emitting section 7C is a “transmissive” light-emitting section that emits the fluorescence L2 mainly through a facing surface (lower surface) thereof opposite to a laser beam irradiation surface (upper surface) thereof that is irradiated with the laser beam L1.

The reflector 80 serves to cause a portion of the laser beam L1 radiated to the light-emitting section 7C that has been reflected by the light-emitting section 7C to be reflected again toward the light-emitting section 7. Providing the reflector 80 makes it possible to improve efficiency in the use of the laser beam L1 radiated from the laser beam 11F. As a result, the unmanned aircraft 1H can emit more high-luminance light.

The lens 81 is a lens for condensing the fluorescence L2 emitted from the light-emitting section 7C and radiating it toward the outside of the unmanned aircraft 1H. The lens 81 is disposed to be fitted in a hole (not illustrated) provided in a lower part of the arm section 3.

In the unmanned aircraft 1H, the laser unit 10F is disposed between the fan 4 and the light-emitting section 7C in a vertical direction. This provides a configuration in which the laser unit 10F is cooled down via the heat sink 14E (fins 14Eb) in an upper part of the laser unit 10F by air that is blasted from the fan 4 and the laser beam L1 can be radiated from a lower surface of the laser unit 10F toward the light-emitting section 7C.

In the unmanned aircraft 1H according to the present embodiment, the two-shaft motor 71 both rotates the fan 4 and rotates the light-emitting section 7C. This makes it possible to bring about the following two effects.

The first effect is to prevent a decrease in light emission efficiency of the laser unit 10F by enhancing heat dissipation efficiency of the laser unit 10F with air that is blasted from the fan 4.

The second effect is to suppress a decrease in light emission efficiency of the light-emitting section 7C. Note here that in a case where the light-emitting section 7C does not rotate, the laser beam L1 radiated from the laser unit 10F (laser element 11F) continues to be radiated intensively to one point of the light-emitting section 7C. This leads to a rise in temperature in that point of the light-emitting section 7C, undesirably causing a decrease in efficiency of conversion from the laser beam L1 into the fluorescence L2 in the light-emitting section 7C. This undesirably results in a decrease in luminance of light that an unmanned aircraft radiates.

On the other hand, in the unmanned aircraft 1H, the rotation of the light-emitting section 7C by the two-shaft motor 71 causes the laser beam L1 radiated from the laser unit 10F (laser element 11F) to be radiated along a circumferential direction of the light-emitting section 7C. That is, the laser beam L1 radiated from the laser unit 10F can be prevented from continuing to be radiated intensively to one point of the light-emitting section 7C. This results in making it possible to suppress a rise in temperature of the light-emitting section 7C, thus making it possible to suppress a decrease in efficiency of conversion from the laser beam L1 into the fluorescence L2 in the light-emitting section 7C. As a result, the unmanned aircraft 1H can radiate high-luminance light.

As noted above, in the unmanned aircraft 1H, the two-shaft motor 71 both rotates the fan 4 and rotates the light-emitting section 7C. This makes it possible with one two-shaft motor 71 to prevent a decrease in light emission efficiency of the laser unit 10F (laser element 11F) and suppress a decrease in conversion efficiency of the light-emitting section 7C.

### Embodiment 9

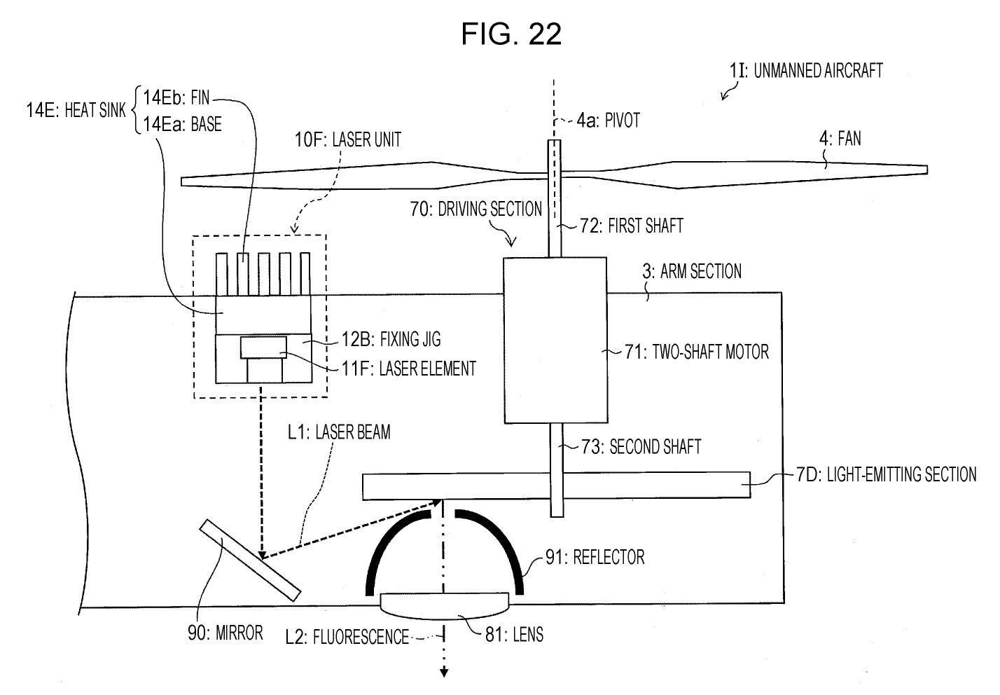

Another embodiment of the present invention is described below with reference to FIG. 22. For convenience of explanation, members having the same functions as those described in the foregoing embodiments are given the same signs and, as such, are not described here.

A configuration of an unmanned aircraft 1I according to the present embodiment is described with reference to FIG. 22. FIG. 22 is a cross-sectional view showing a configuration of a fan 4 and the area therearound of the unmanned aircraft 1I.

As shown in FIG. 22, an unmanned aircraft 1I includes a light-emitting section 7D and a reflector 91 instead of the light-emitting section 7C and reflector 80 of the unmanned aircraft 1H according to Embodiment 8. Further, the unmanned aircraft 1I includes a mirror 90.

The light-emitting section 7D is formed by applying a phosphor to a light-reflecting substrate such as a metal, a mirror, a multilayer film. The light-emitting section 7D is configured such that its lower surface is a surface to which the phosphor has been applied. The light-emitting section 7D is a “reflective” light-emitting section that emits fluorescence L2 through the laser beam irradiation surface (lower surface) that is irradiated with a laser beam L1.

The mirror 90 is a mirror, provided below the laser unit 10F inside the arm section 3, for reflecting, toward a lower surface of the light-emitting section 7D, the laser beam L1 emitted from the laser unit 10F.

The reflector 91 condenses, toward the lens 81, the fluorescence L2 emitted by the light-emitting section 7D. Note here than the fluorescence L2 is diffusely radiated from the light-emitting section 7D. Therefore, in the absence of the reflector 91, a portion of the fluorescence L2 leaks out of the lens 81. On the other hand, by including the reflector 91, the unmanned aircraft 1H can condense, toward the lens 81, the fluorescence L2 radiated by the light-emitting section 7D. This makes it possible to reduce leakage of the fluorescence L2 out of the lens 81.

As noted above, in the unmanned aircraft 1I according to the present embodiment, the laser beam L1 emitted from the laser unit 10F is reflected by the mirror 90 and radiated to the lower surface of the light-emitting section 7D. Moreover, the laser beam L1 is converted by the light-emitting section 7D into the fluorescence L2, and the fluorescence L2 is radiated toward the outside via the lens.

In the unmanned aircraft 1I, as in the unmanned aircraft 1H according to Embodiment 8, the rotation of the light-emitting section 7D by the two-shaft motor 71 makes it possible to prevent the laser beam L1 radiated from the laser unit 10F from continuing to be radiated intensively to one point of the light-emitting section 7D. This results in making it possible to suppress a rise in temperature of the light-emitting section 7D, thus making it possible to suppress a decrease in efficiency of conversion from the laser beam L1 into the fluorescence L2 in the light-emitting section 7D. As a result, the unmanned aircraft 1I can radiate high-luminance light.

Although the foregoing has described unmanned aircrafts as moving bodies of the present invention, moving bodies of the present invention are not limited to unmanned aircrafts. For example, moving bodies of the present invention may be moving bodies that move on land or on water by gaining propulsion through a fan. Alternatively, these moving bodies may be manned moving bodies or unmanned moving bodies.

### CONCLUSION

A moving body (unmanned aircraft 1A to 1G or 1A′ to 1C′) according to Aspect 1 of the present invention is a moving body (unmanned aircraft) that gains propulsion through a fan 4, including: at least one light source (laser unit 10A to 10D, 10A′ to 10C′, or 10Ca to 10Cd or laser element 11Ea to 11Ec) that emits a laser beam (laser beam L1, red light RL, green light GL, and blue light BL), wherein the light source (laser unit 10A to 10D, 10A′ to 10C′, or 10Ca to 10Cd, or laser elements 11Ea to 11Ec) has its heat dissipation efficiency enhanced by air that is blasted by the fan 4.

This feature makes it possible to emit high-luminance light by using the light sources, which are smaller in size than LED elements and HID elements and emit laser beams. This results in making it possible to make the unmanned aircraft lighter, making it possible to burn less cell (battery) power. Further, the undesirable decrease in light emission efficiency of the light elements due to heat that is generated when the light elements radiate laser beams can be addressed by preventing a decrease in light emission efficiency of the light sources by cooling down the light sources with air that is blasted by the fan.

This brings about an effect of making it possible to provide a moving body, including a light source, that is capable of suppressing a rise in temperature of the light source and emitting high-luminance light from the light source.

In Aspect 1, a moving body (unmanned aircraft 1A to 1E, 1G, or 1A′ to 1C′) according to Aspect 2 of the present invention may be configured to further include a light-emitting section 7A or 7B that emits fluorescence L2 by being irradiated with the laser beam L1 emitted from the light source (laser unit 10A to 10D, 10A′ to 10C′, or 10Ca to 10Cd).

The foregoing configuration makes it possible to emit a high-luminance fluorescence from the light-emitting section by using a laser beam.

In Aspect 1, a moving body (unmanned aircraft 1F) according to Aspect 3 of the present invention may be configured to further include at least three light sources (laser elements 11Ea to 11Ec) that emit laser beams (red light RL, green light GL, and blue light BL) differing in wavelength from one another; and a projection section (MEMS mirror 52) that shows a picture by merging and radiating the laser beams (red light RL, green light GL, and blue light BL) emitted from the light sources (laser elements 11Ea to 11Ec).

The foregoing configuration makes it possible to project a bright picture by using laser beams.

In any of Aspects 1 to 3, a moving body (unmanned aircraft 1A to 1G or 1A′ to 1C′) according to Aspect 4 of the present invention is preferably configured to further include: a body section (housing 2); and an arm section 3 or 3a to 3d that extends from the body section (housing 2) and supports the fan 4, wherein the arm section 3 or 3a to 3d is provided with the light source (laser unit 10A to 10D, 10A′ to 10C′, or 10Ca to 10Cd, or laser elements 11Ea to 11Ec).

According to the foregoing configuration, the light sources are not configured to be provided in a body section in which a light-emitting section, a control section, a sensor, a camera, and the like are housed. This makes it possible to prevent the heat-generating members from being concentrated in the body section, making it possible to prevent heat that is generated from the light sources from affecting electronic equipment such as the light-emitting section, the control section, the sensor, and the camera.

In any of Aspects 1 to 3, a moving body (unmanned aircraft 1A to 1G or 1A′ to 1C′) according to Aspect 5 of the present invention is preferably configured such that the light source (laser unit 10A to 10D, 10A′ to 10C′, or 10Ca to 10Cd, or laser elements 11Ea to 11Ec) includes a heat sink 14A to 14D or 14A′ and dissipates heat via the heat sink 14A to 14D or 14A′.

The foregoing configuration makes it possible to more efficiently cool down the light source via the heat sink.

In Aspect 4, a moving body (unmanned aircraft 1A to 1G or 1A′ to 1C′) according to Aspect 6 of the present invention may be configured such that the fan 4 has a pivot 4a supported by the arm section 3 or 3a to 3d, and at least a part of the light source (laser unit 10A to 10D, 10A′ to 10C′, or 10Ca to 10Cd, or laser elements 11Ea to 11Ec) is provided between a circle, centered at the pivot 4a of the fan 4, that has a 20% radius of a radius of the fan 4 and a circle, centered at the pivot 4a of the fan 4, that has a 100% radius of the radius of the fan 4.

According to the foregoing configuration, since the volume of air that is blasted from the fan is large in a region between a circle, centered at the pivot of the fan, that has a 20% radius of the radius of the fan and a circle, centered at the pivot of the fan, that has a 100% radius of the radius of the fan, the light source can be efficiently cooled down by providing the light source in this region.

In Aspect 4, a moving body (unmanned aircraft 1B, 1B′, or 1E) according to Aspect 7 of the present invention may be configured such that the fan 4 has a pivot 4a supported by the arm section 3 or 3a to 3d, and at least a part of the light source (laser units 10B, 10B′ or 10D) is provided between a circle, centered at the pivot 4a of the fan 4, that has a 100% radius of a radius of the fan 4 and a circle, centered at the pivot 4a of the fan 4, that has a 120% radius of the radius of the fan 4.

According to the foregoing configuration, since the volume of air that is blasted from the fan is large in a region between a circle, centered at the pivot of the fan, that has a 100% radius of the radius of the fan and a circle, centered at the pivot of the fan, that has a 120% radius of the radius of the fan, the light source can be efficiently cooled down by providing the light source in this region.

In Aspect 2, a moving body (unmanned aircraft 1D) according to Aspect 8 of the present invention may be configured to further include: a body section (housing 2); and an arm section 3a to 3d that extends from the body section (housing 2) and supports the fan 4, wherein the arm section 3a to 3d is provided with the light source (laser unit 10Ca to 10Cd) and the light-emitting section 7B.

According to the foregoing configuration, the light-emitting sections are not configured to be provided in a body section in which a control section, a sensor, a camera, and the like are housed. This makes it possible to prevent the heat-generating members from being concentrated in the body section, making it possible to prevent heat that is generated from the light-emitting sections from affecting electronic equipment such as the control section, the sensor, and the camera.

In Aspect 8, a moving body (unmanned aircraft 1D) according to Aspect 9 of the present invention is preferably configured such that the light-emitting section 7B has its heat dissipation efficiency enhanced by air that is blasted by the fan 4.

The foregoing configuration makes it possible to prevent a decrease in wavelength conversion of the light-emitting section by cooling down the light-emitting section.

In Aspect 2, a moving body (unmanned aircraft 1A to 1C, 1E, 1G, or 1A′ to 1C′) according to Aspect 10 of the present invention may be configured to further include: a body section (housing 2); and an arm section 3 that extends from the body section (housing 2) and supports the fan 4, wherein the body section (housing 2) is provided with the light-emitting section 7A.

The foregoing configuration makes it possible to radiate the fluorescence from the body section.

In Aspect 10, a moving body (unmanned aircraft 1A to 1C, 1E, 1G, or 1A′ to 1C′) according to Aspect 11 of the present invention is preferably configured to further include a plurality of the arm sections 3, wherein each of the arm sections 3 is provided with the light source (laser unit 10A to 10D or 10A′ to 10C′), and laser beams L1 radiated from a plurality of the light sources (laser units 10A to 10D and 10A′ to 10C′) are radiated to the light-emitting section 7A.

The foregoing configuration makes it possible to radiate more high-luminance light by causing the light-emitting section provided in the body section to emit the laser beams radiated from the plurality of light sources.

In Aspect 2, a moving body (unmanned aircraft 1A to 1D, 1G, 1A′, or 1B′) according to Aspect 12 of the present invention is preferably configured to further include: a body section (housing 2); and an arm section 3 or 3a to 3d that extends from the body section (housing 2) and supports the fan 4, wherein the laser beam emitted from the light source (laser unit 10A to 10D, 10A′, 10B′, or 10Ca to 10Cd) is radiated to the light-emitting section 7A or 7B via an interior of the arm section 3 or 3a to 3d.

The foregoing configuration prevents the laser beam emitted from the light source from leaking out of the moving body, thus making it possible to give improved safety.

In Aspect 2, a moving body (unmanned aircraft 1C to 1E or 1C′) according to Aspect 13 of the present invention is preferably configured such that the laser beam L1 emitted from the light source (laser unit 10C, 10Ca to 10Cd, 10D, or 10C′) is radiated to the light-emitting section 7A or 7B via an optical fiber 30 or 30a to 30d.

The foregoing configuration prevents the laser beam L1 from leaking out of the moving body, thus making it possible to give improved safety. This also provides high vibration durability.

In Aspect 2, a moving body (unmanned aircraft 1A to 1C, 1E, 1G, or 1A′ to 1C′) according to Aspect 14 of the present invention may be configured to further include: a body section (housing 2); an arm section 3 that extends from the body section (housing 2) and supports the fan 4; and a driving section 70 that rotates the fan 4 and the light-emitting section 7C or 7D, wherein the arm section 3 is provided with the light source (laser unit 10F) and the light-emitting section 7C or 7D.

According to the foregoing configuration, the rotation of the light-emitting section by the driving section makes it possible to prevent the laser beam radiated from the light source from continuing to be radiated intensively to one point of the light-emitting section. This results in making it possible to suppress a rise in temperature of the light-emitting section, thus making it possible to suppress a decrease in efficiency of conversion from the laser beam L1 into the fluorescence in the light-emitting section. This results in making it possible to radiate high-luminance light. This makes it possible with one driving section to prevent a decrease in light emission efficiency of the light source and suppress a decrease in conversion efficiency of the light-emitting section.

In Aspect 14, a moving body (unmanned aircraft 1H) according to Aspect 15 of the present invention may be configured such that the light source (laser unit 10F) is disposed between the fan 4 and the light-emitting section 7C.

The foregoing configuration makes it possible to cool down the light source with air that is blasted from the fan on one side of the light source and radiate the laser beam to the light-emitting section from another side of the light source.

The present invention is not limited to any of the embodiments described above but may be altered in various ways within the scope of the claims, and an embodiment based on a proper combination of technical means disclosed in different embodiments is encompassed in the technical scope of the present invention. Furthermore, a new technical feature can be formed by a combination of technical means respectively disclosed in embodiments.

### REFERENCE SIGNS LIST

1A to 1G, 1A′ to 1C′, 1F, 1H, 1I Unmanned aircraft
2 Housing (body section)
3, 3a to 3d Arm section
4 Fan
4a Pivot
7A, 7B, 7C, 7D Light-emitting section
10A to 10F, 10A′ to 10C′, 10Ca to 10Cd Laser unit (light source)
11Ea to 11Ec Laser element (light source)
14A to 14E, 14A′ Heat sink
30, 30a to 30d Optical fiber
52 MEMS mirror (projection section)
70 Driving section
L1 Laser beam
L2 Fluorescence
RL Red light (laser beam)
GL Green light (laser beam)
BL Blue light (laser beam)

1. A moving body that gains propulsion through a fan, comprising:
at least one light source that emits a laser beam,
wherein the light source has its heat dissipation efficiency enhanced by air that is blasted by the fan.

2. The moving body according to claim 1, further comprising a light-emitting section that emits fluorescence by being irradiated with the laser beam emitted from the light source.

3. The moving body according to claim 1, further comprising:
at least three light sources that emit laser beams differing in wavelength from one another; and
a projection section that shows a picture by merging and radiating the laser beams emitted from the light sources.

4. The moving body according to claim 1, further comprising:
a body section; and
an arm section that extends from the body section and supports the fan,
wherein the arm section is provided with the light source.

5. The moving body according to claim 1, wherein the light source includes a heat sink and dissipates heat via the heat sink.

6. The moving body according to claim 4, wherein
the fan has a pivot supported by the arm section, and
at least a part of the light source is provided between a circle, centered at the pivot of the fan, that has a 20% radius of a radius of the fan and a circle, centered at the pivot of the fan, that has a 100% radius of the radius of the fan.

7. The moving body according to claim 4, wherein
the fan has a pivot supported by the arm section, and
at least a part of the light source is provided between a circle, centered at the pivot of the fan, that has a 100% radius of a radius of the fan and a circle, centered at the pivot of the fan, that has a 120% radius of the radius of the fan.

8. The moving body according to claim 2, further comprising:
a body section; and
an arm section that extends from the body section and supports the fan,
wherein the arm section is provided with the light source and the light-emitting section.

9. The moving body according to claim 8, wherein the light-emitting section has its heat dissipation efficiency enhanced by air that is blasted by the fan.

10. The moving body according to claim 2, further comprising:
a body section; and
an arm section that extends from the body section and supports the fan,
wherein the body section is provided with the light-emitting section.

11. The moving body according to claim 10, further comprising a plurality of the arm sections,
wherein each of the arm sections is provided with the light source, and
laser beams radiated from a plurality of the light sources are radiated to the light-emitting section.

12. The moving body according to claim 2, further comprising:
a body section; and
an arm section that extends from the body section and supports the fan,
wherein the laser beam emitted from the light source is radiated to the light-emitting section via an interior of the arm section.

13. The moving body according to claim 2, wherein the laser beam emitted from the light source is radiated to the light-emitting section via an optical fiber.

14. The moving body according to claim 2, further comprising:
a body section;
an arm section that extends from the body section and supports the fan; and
a driving section that rotates the fan and the light-emitting section,
wherein the arm section is provided with the light source and the light-emitting section.

15. The moving body according to claim 14, wherein the light source is disposed between the fan and the light-emitting section.
